(19) United States
(12) Patent Application Publication
(10) Pub. No.: US 2016/0267603 A1
(43) Pub. Date: Sep. 15, 2016

(54) Systems and Methods for Tracking and Validating Commodities Purchases

(71) Applicant: GOLDQUEST REFINEMENT SERVICES LTD, Buffalo, NY (US)

(72) Inventor: Gary WOLCH, Buffalo, NY (US)

(21) Appl. No.: 15/036,063

(22) PCT Filed: Nov. 12, 2014
(86) PCT No.: PCT/US14/65329

§ 371 Date: May 11, 2016

Related U.S. Application Data
(60) Provisional application No. 61/902,328, filed on Nov. 11, 2013.

(51) Int. Cl. G06Q 40/08; G06Q 40/04; G06Q 30/06

(52) U.S. Cl. CPC G06Q 40/08; G06Q 30/0601; G06Q 40/04

(57) ABSTRACT

Systems and methods for tracking and validating commodities purchases are disclosed. One embodiment of the present invention is a system having a buyer-operated computer, an electronic data storage device, a processor in electronic communication with the electronic data storage device, and a network connection from the processor to a customer database having a list of unauthorized customers, a shipment provider, a commodity price feed, and the buyer-operated computer. Some embodiments of the present invention include pages, such as buyer, inventory, and shipping pages to track and validated purchased commodities.

### BACKGROUND OF THE INVENTION

This application claims priority to U.S. Provisional Application No. 61/902,328, filed on Nov. 11, 2013, now pending, the disclosure of which is incorporated herein by reference.

### FIELD OF THE INVENTION

The invention relates to systems and methods for tracking and validating commodities purchases. For example, commodities may include, but are not limited to gold, silver, copper, platinum, watches, bullion, coins, diamonds, electronics, and scrap metal.

### BACKGROUND OF THE INVENTION

Buying and selling commodities is a fundamental but sophisticated business. Although commodities can be traded as fungible assets, in practice, the quality (and thereby value) of the commodity may vary greatly. Furthermore, regulatory barriers exist that make it difficult for all but the most sophisticated users to effectively buy and sell commodities.

Buying and selling items that can be recycled into commodities provides additional challenges. Although it is possible to buy and sell pure commodities, it is more likely that a seller (herein, a “customer”) will sell an item that can be recycled into various commodities. For example, a customer may want to sell a ring that can be recycled into gold, diamonds, and silver. One challenge is determining, without destroying the item, the amount and value of the commodities in the item. Skilled appraisers may be able to perform this task, but the demand for these appraisers far outpace the supply. A buyer cannot staff, without great expense, each location with an experienced appraiser. Furthermore, many appraisers cannot properly assess an item without being able to view or perform certain tests on the item.

Another challenge is properly pricing an item in a competitive commodities marketplace. For example, if the buyer offers a price that is too low, the customer may go to a different buyer. If the buyer offers a price that is too high, the buyer risks taking a loss. A skilled buyer may be able to judge an appropriate price to offer for an item, but the skilled buyer is not a scalable resource. Systems and methods are needed to provide inexperienced buyers with information and controls that reduce the risk during a commodities transaction.

Another challenge is complying with local, state, and federal regulations in various municipalities for the buying and selling of commodities. Regulations are not uniform from municipality to municipality, and it quickly becomes difficult to comply if commodity transactions occur in multiple municipalities. It is estimated that there are over 80,000 municipalities in the United States. For example, buyers may be required to run background checks on their customers or hold onto purchased items for certain lengths of time. In some municipalities, the buyer may need to post a static purchase price at the start of each day.

Previous systems and methods have been concerned with buying and selling commodities at a fair (or profitable) price. But these systems and methods have difficulty tracking purchased commodities, especially when the commodities can be manipulated or lost during transportation. Up to this point, tracking and validating commodities purchases remains the riskiest and most time-consuming aspect of commodity transactions. Furthermore, systems and methods for buying and selling commodities have not simplified the transaction process to a point where unsophisticated buyers can participate without this risk.

### DESCRIPTION OF THE DRAWINGS

For a fuller understanding of the nature and objects of the invention, reference should be made to the following detailed description taken in conjunction with the accompanying drawings, in which:

FIG. 1 is a state diagram of a system or method in keeping with the present invention;

FIG. 2 is a state diagram further describing a buy state in keeping with the present invention;

FIG. 3 is a state diagram further describing the inventory process in keeping with the present invention;

FIG. 4 is a state diagram further describing the shipping process in keeping with the present invention;

FIG. 5 is a state diagram further describing the flagging process in keeping with the present invention;

FIG. 6 is a state diagram further describing the verifying process in keeping with the present invention;

FIG. 7 is a state diagram further describing account administration in keeping with the present invention;

FIG. 8 is a diagram showing access, information, and account details for an administrative account in keeping with the present invention;

FIG. 9 is a diagram showing account details in keeping with the present invention;

FIG. 10 is a diagram showing store details in keeping with the present invention;

FIG. 11 is a diagram showing user details in keeping with the present invention;

FIG. 12 is a diagram showing role details in keeping with the present invention;

FIG. 13 is a diagram showing customer reports in keeping with the present invention;

FIG. 14 is a diagram showing police reports in keeping with the present invention;

FIG. 15 is a diagram showing drawer reports in keeping with the present invention;

FIG. 16 is a diagram showing shipping reports in keeping with the present invention;

FIG. 17 is a diagram showing inventory reports in keeping with the present invention;

FIG. 18 is a diagram showing transaction reports in keeping with the present invention;

FIG. 19 is a drawing showing a user dashboard in keeping with the present invention;

FIG. 20 is a drawing showing a buy page presented to a user in keeping with the present invention;

FIG. 21 is a drawing showing a manager/administrator override on a buy page presented to a user in keeping with the present invention;

FIG. 22A-H are drawings of the shipping process for users in keeping with the present invention;

FIG. 23 is a drawing of the shipping process for users in keeping with the present invention;

FIGS. 24A-39 are drawings of screens as seen by an administrator/corporate use of the system used to add/delete/change companies, regions, stores, employees, and referral sources in keeping with the present invention;

FIGS. 40-41 are drawings showing sample refining statements in keeping with the present invention;

FIGS. 42-46 are drawings of screens as seen by an associate for the “Buy” process;

FIGS. 47A-48 are drawings of screens of the “Resale” process as seen by all system users; and

FIGS. 49-53B are drawings of reports in keeping with the present invention.

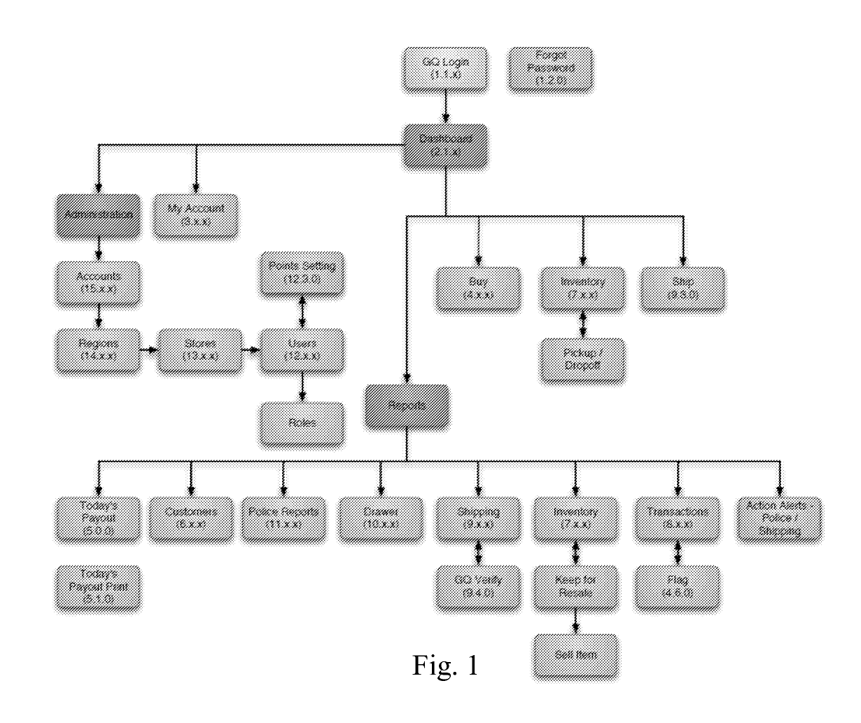

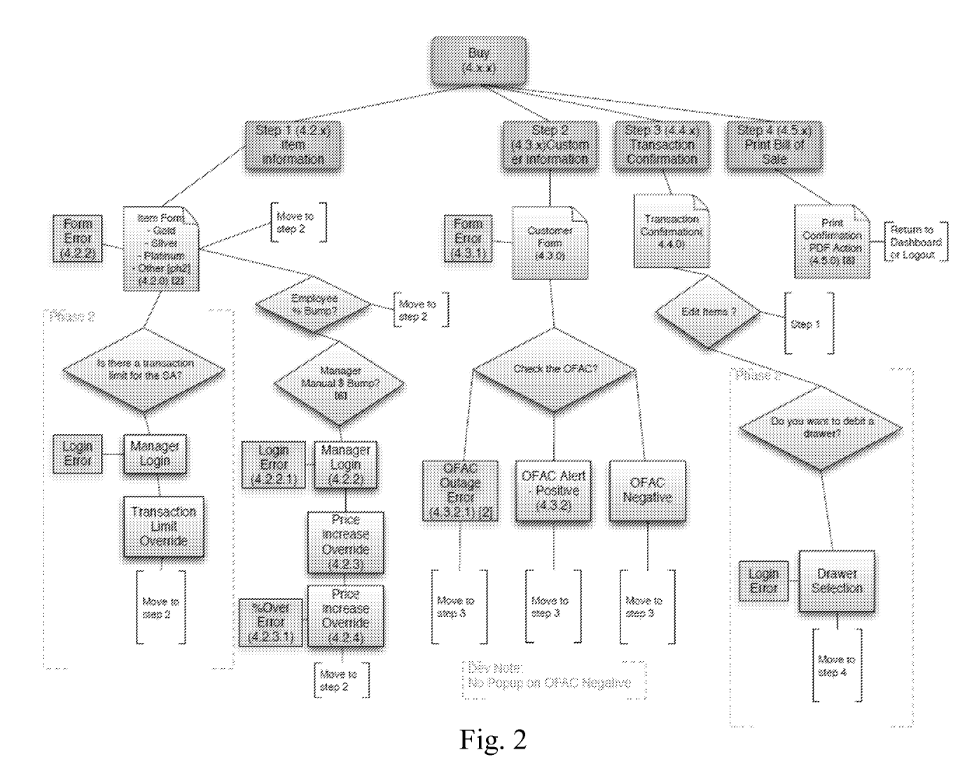

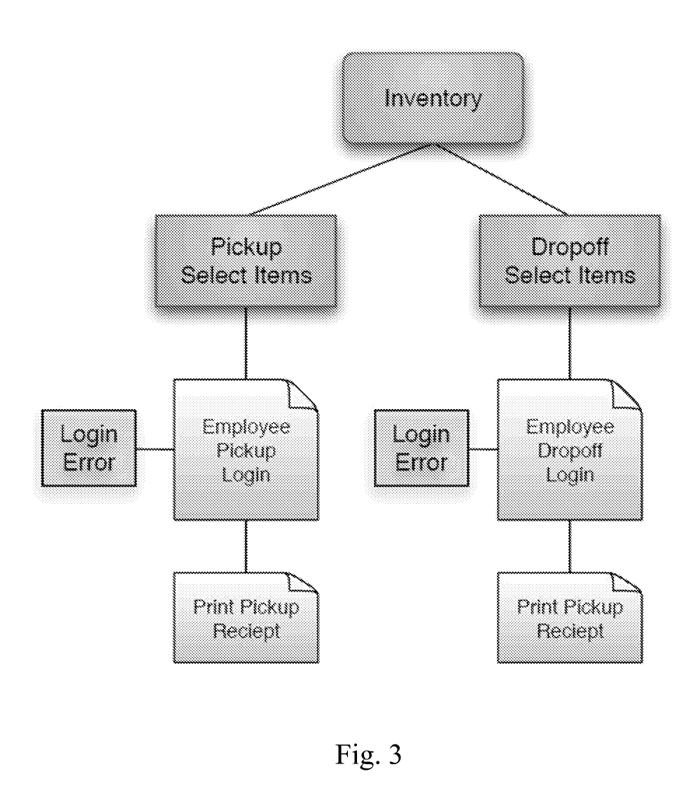

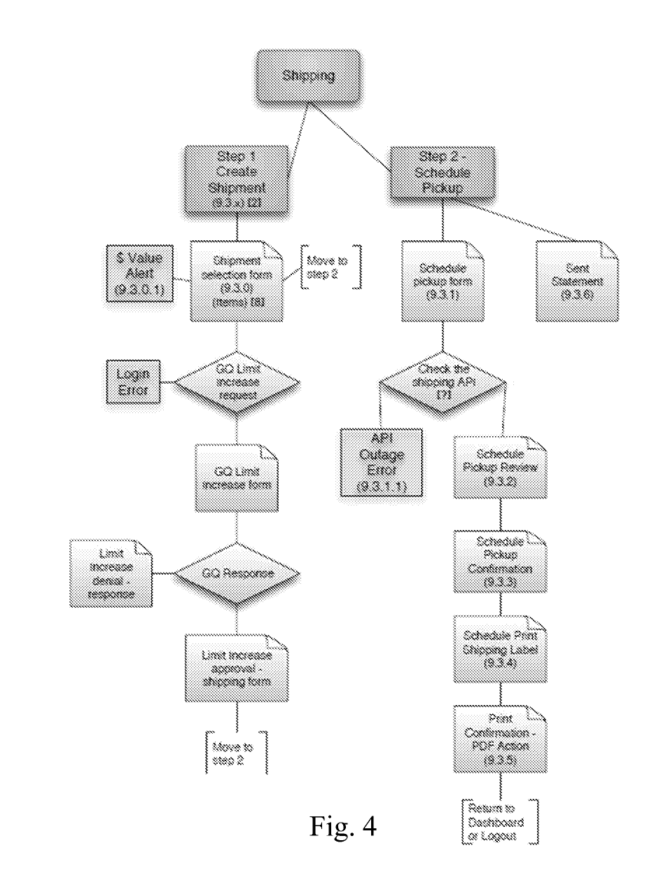

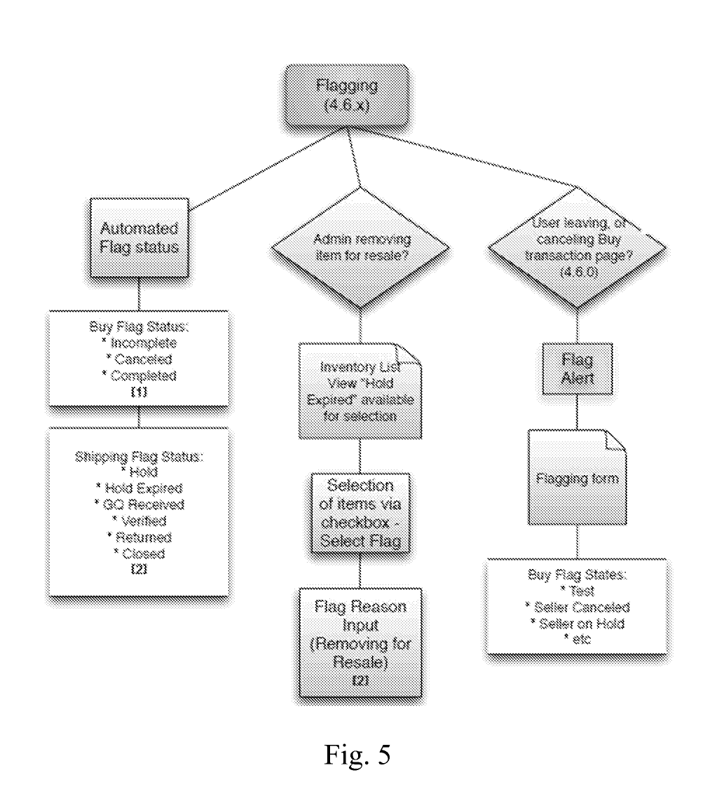

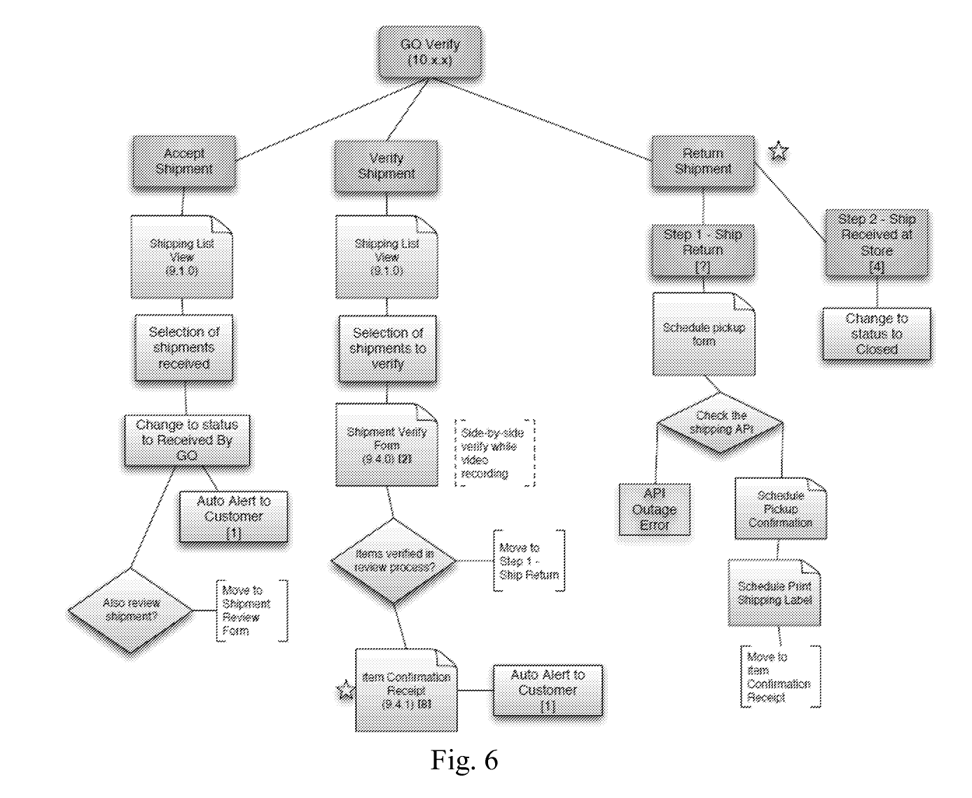

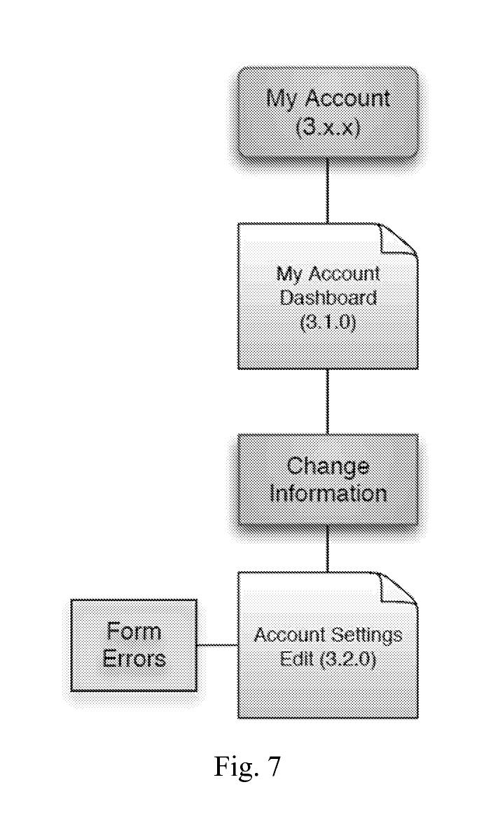

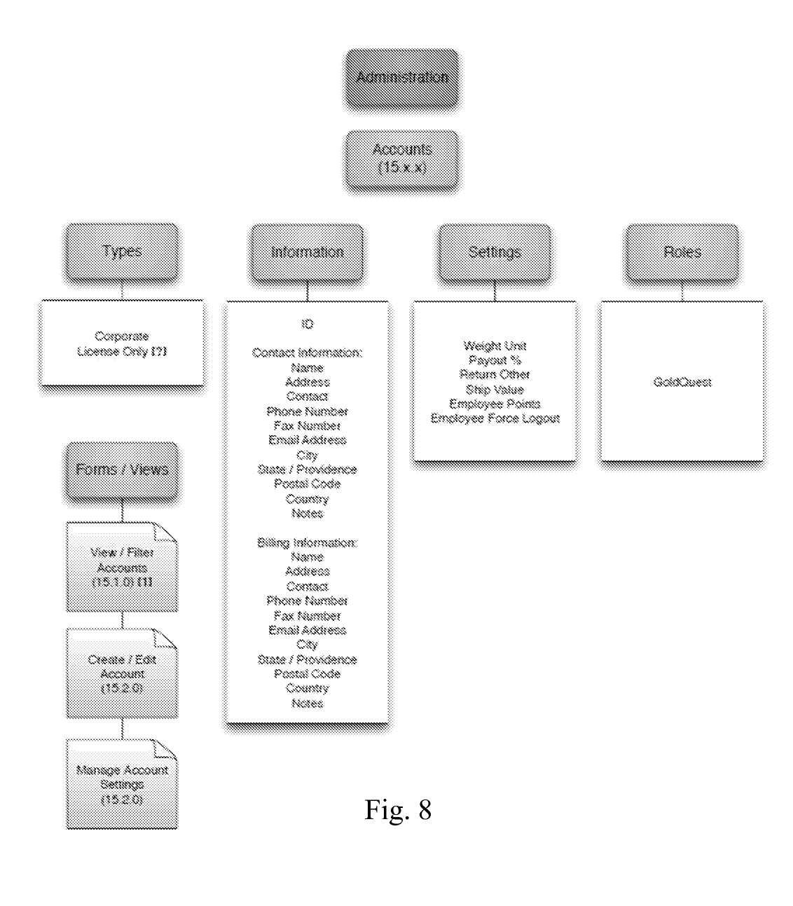

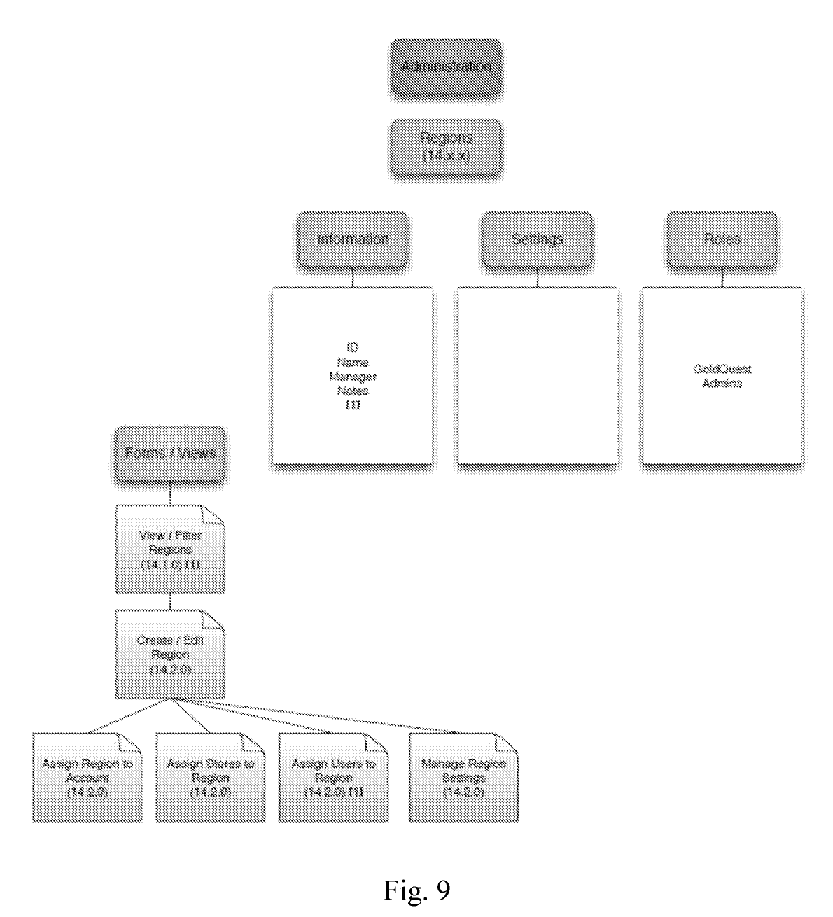

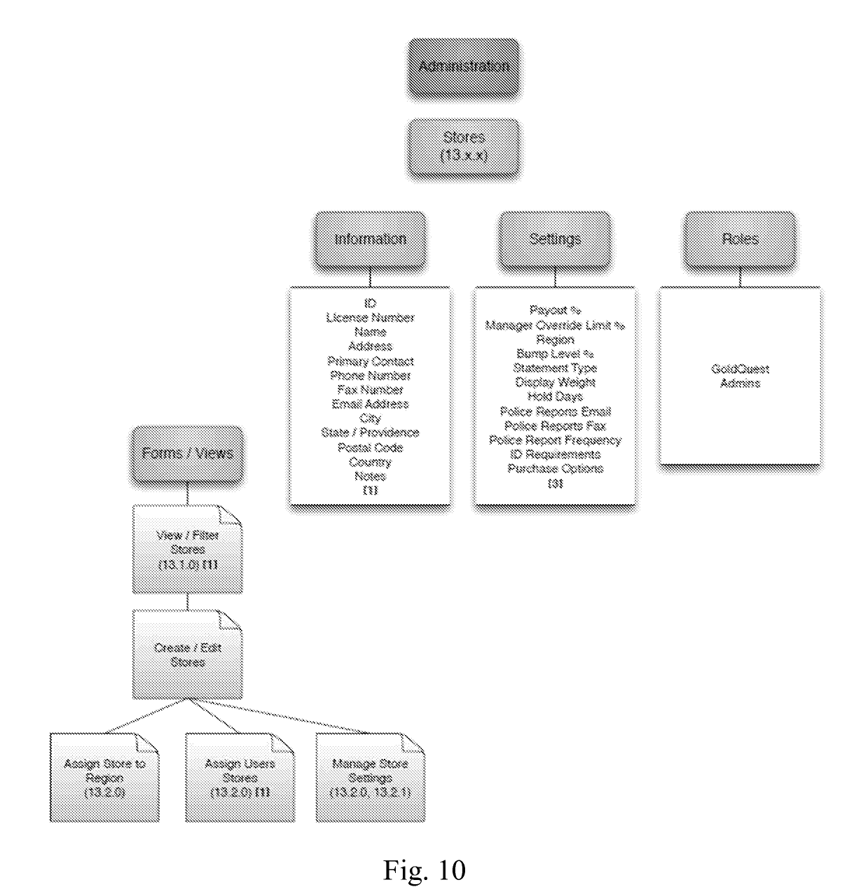

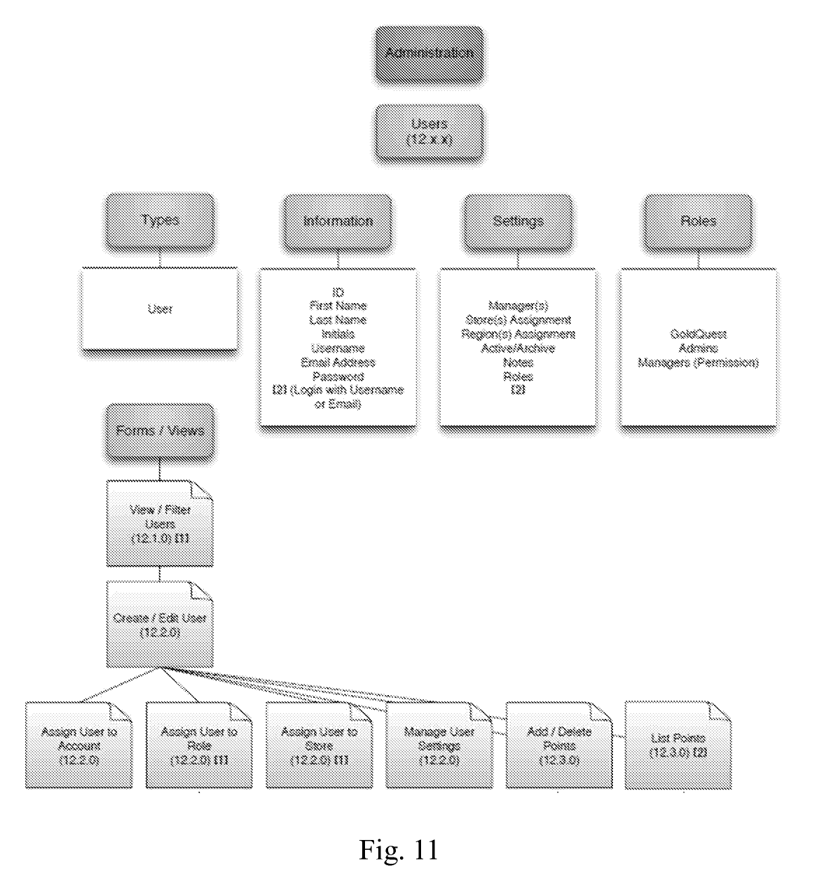

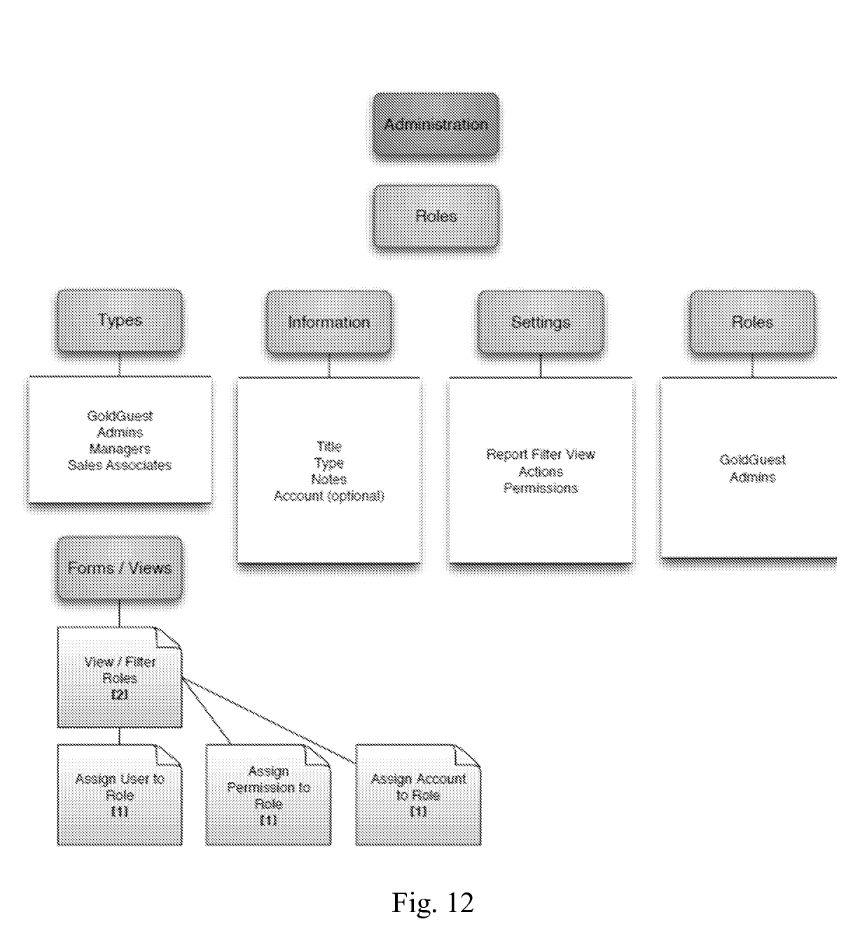

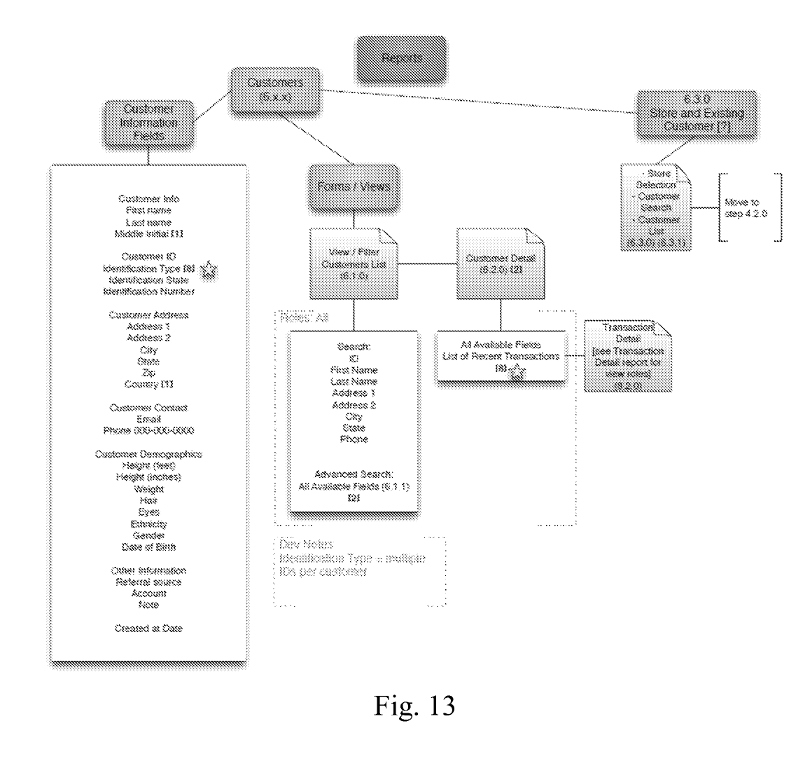

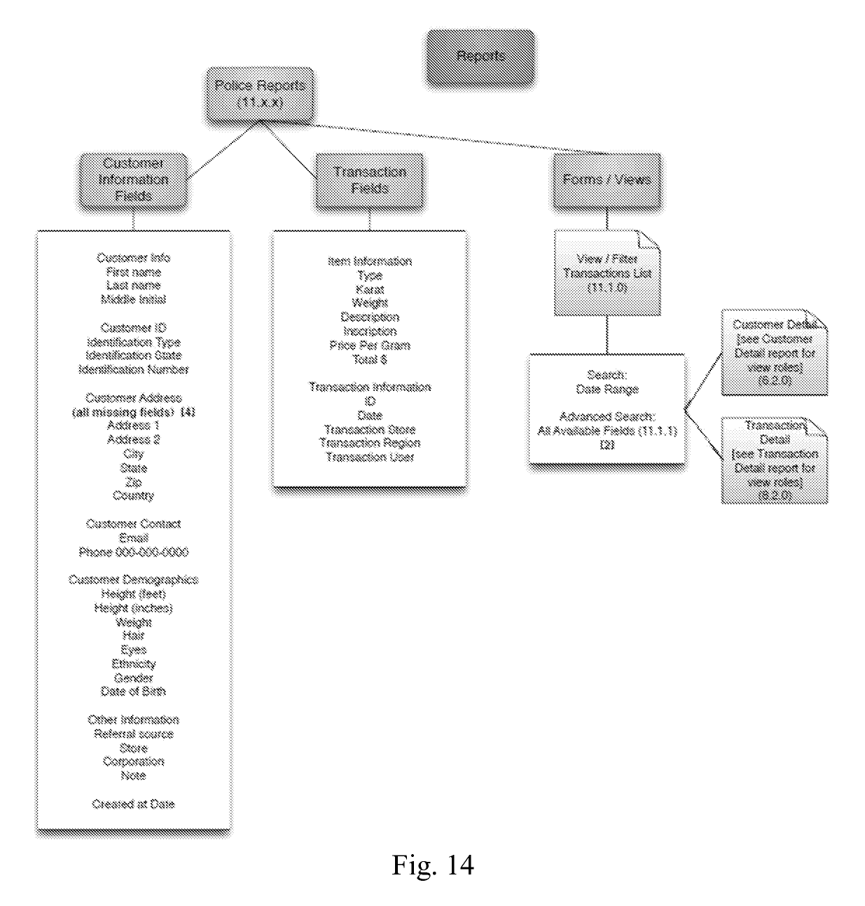

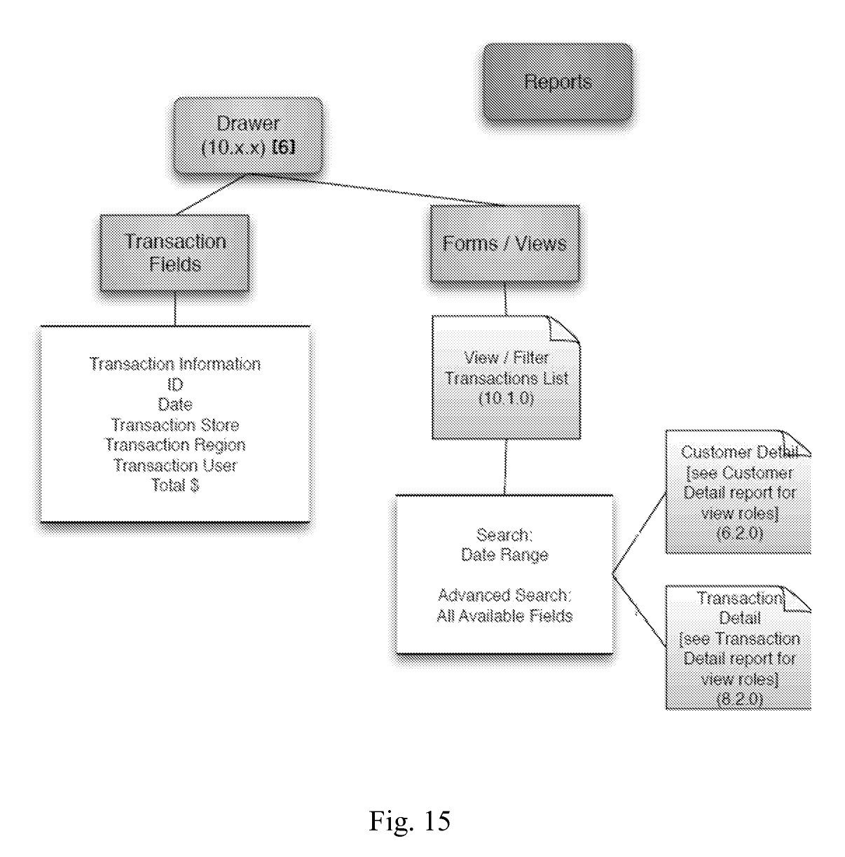

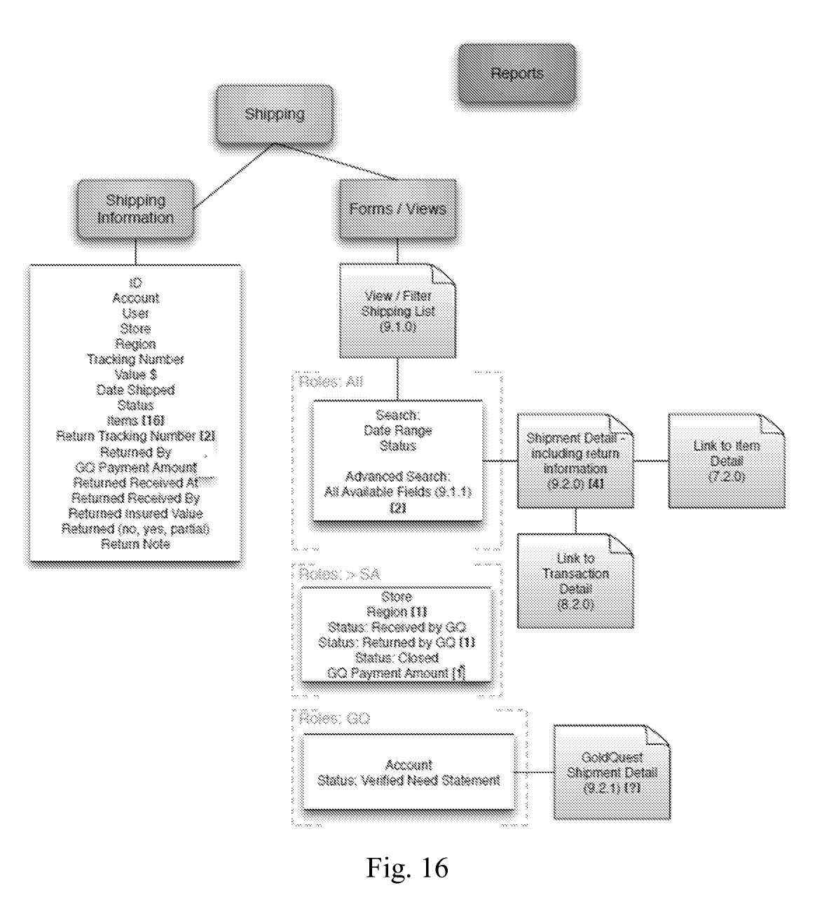

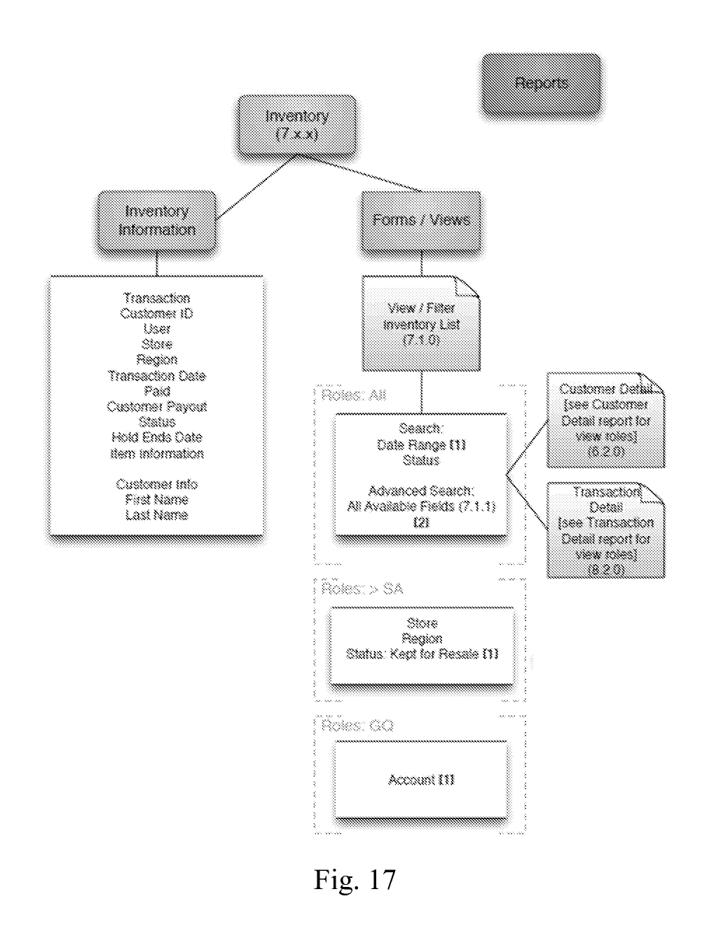

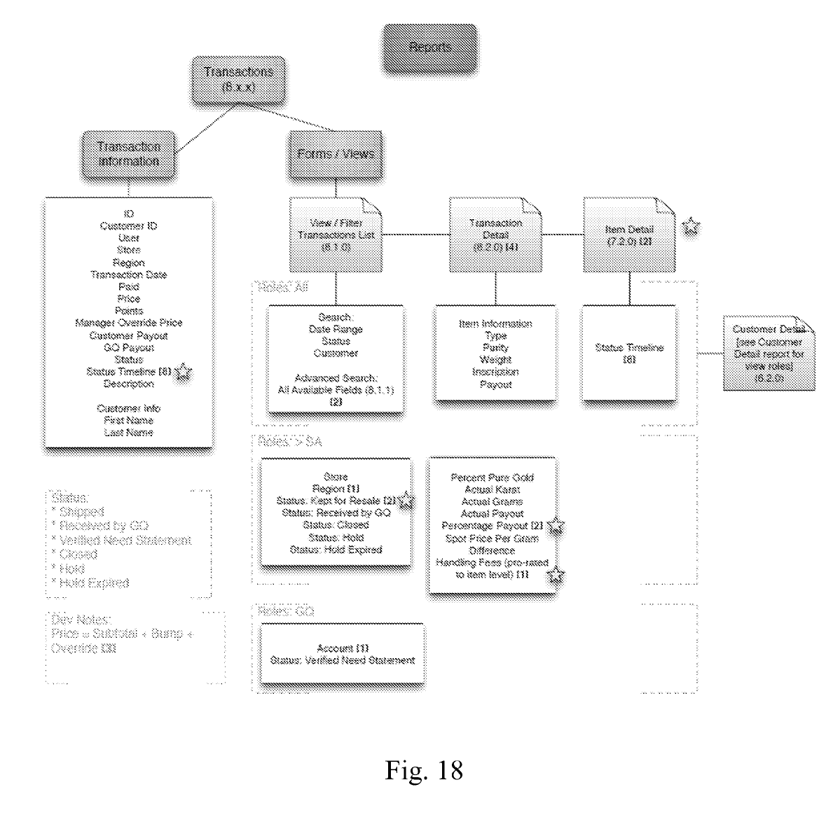

### SUMMARY OF THE INVENTION

Systems and methods for tracking and validating commodities purchases are disclosed. One embodiment can be described as a system comprising a buyer-operated computer. The buyer-operated computer may have a municipality attribute. The buyer-operated computer may have an image capture device and the displayed buyer page is configured to receive an image as a portion of a commodity description. The image may be a video.

The system may further comprise an electronic data storage device and a processor in electronic communication with the electronic data storage device. The processor may be configured to store the commodity description and customer information from the buyer-computer in the electronic data storage device. The processor may also be configured to send computer-readable instructions to cause the buyer-operated computer to display whether the received customer information matches an unauthorized customer in the customer database. The processor may also be configured to determine the commodity holding period based on the municipality attribute of the buyer-operated computer. The processor may also be configured to store the commodity holding period such that the holding period is associated with the respective commodity description in the electronic data storage device. The processor may also be configured to retrieve shipping information and insurance information from the shipping provider for purchased commodities based on the commodity price feed.

In one embodiment, the processor is further configured to retrieve a license application from the electronic data storage device, prepopulate the retrieved license application based on the municipality attribute of the buyer-operated computer, and send the prepopulated license application to the buyer-operated computer. In another embodiment, the processor may also be configured to generate a payout offering sheet based on the municipality attribute of the buyer-operated computer.

The system may further comprise a network connection from the processor to a customer database having a list of unauthorized customers, a shipment provider, a commodity price feed, and the buyer-operated computer. The commodity price feed may be a New York Mercantile Exchange fee or a London AM or PM fix feed.

The system may further comprise a buyer page, recorded on the electronic data storage device, comprising computer-readable instructions to cause the buyer-operated computer to display the buyer page. The displayed buyer page may be configured to receive a commodity description and customer information associated with a commodity. The displayed buyer page may also be configured to display a current price for the commodity derived from the commodity price feed. The displayed buyer page may also be configured to display a suggested buy price for the commodity based on the current price and the municipal attribute of the buyer operated computer. The suggested buy price may be based on the municipality attribute of the buyer-operated computer. In one embodiment, the buyer page is further configured to display an incentive value based on a buy price.

The system may further comprise an inventory page, recorded on the electronic data storage device, comprising computer-readable instructions to cause the buyer-operated computer to display the inventory page. The displayed inventory page may be configured to track a plurality of purchased commodities. The displayed inventory page may also display a current price for each of the plurality of purchased commodities ready for shipment. The current price may be derived from the commodity price feed.

The system may further comprise a shipping page, recorded on the electronic data storage device, comprising computer-readable instructions to cause the buyer-operated computer to display the shipping page. The displayed shipping page may be configured to display shipping eligibility for each purchased commodity based on a holding period. The displayed shipping page may also be configured to display shipping information for shipped commodities.

In one embodiment, the system further comprises an expert-operated computer. In such an embodiment, the processor may be configured to send the commodity description to the expert-operated computer; and receive valuation information from the expert-operated computer based on the sent commodity description.

In another embodiment, the system further comprises a dashboard page, recorded on the electronic data storage device, comprising computer-readable instructions to cause the buyer-operated computer to display the dashboard page. The dashboard page may be configured to display messages to the buyer. The displayed messages may comprise shipping alerts and warnings.

In another embodiment, the processor is also configured to retrieve a tracking number from the shipping provider, and the shipping page is also configured to display the tracking number. The insurance information is based on the municipality of the buyer-operated computer.

The present invention can also be described as a method for tracking and validating commodities purchase. For example, one embodiment comprises the following steps:

Displaying a buyer page on a buyer-operated computer, the buyer-operated computer having a municipality attribute. Receiving, through the buyer page, a commodity description and customer information associated with a commodity to be purchased. Storing, in an electronic data storage device, the commodity description and the customer information associated with the commodity to be purchased. Validating the customer information through a customer database containing unauthorized customers, and if unauthorized, displaying, through the buyer page, a warning indicator. Displaying, through the buyer page, a current price for the commodity to be purchased derived from a commodity price feed. The commodity price feed may be, for example, a New York Mercantile Exchange feed or a London AM or PM fix feed.

The method further comprises displaying, through the buyer page, a suggested purchase price for the commodity based on the current price and the municipal attribute of the buyer-operated computer. Calculating, based on the municipal attribute of the buyer-operated computer, a holding period for each commodity stored in the electronic data storage device. Storing, in the electronic data storage device, the holding period associated with each commodity. Displaying, through a shipping page, a shipping eligibility for each commodity stored in the electronic data storage device based on the associated holding period. Retrieving, from a shipping interface, shipping information and insurance information from the shipping provider for purchased commodities based on the commodity price feed, and displaying, through the shipping page, shipping information for shipped commodities. The insurance information may be based on the municipality of the buyer-operated computer.

In one embodiment, the method further comprises the steps of retrieving a license application from the electronic data storage device, prepopulating the retrieved license application based on the municipality attribute of the buyer-operated computer, and sending the prepopulated license application to the buyer-operated computer.

In another embodiment, the buyer-operated computer has an image capture device and the method further comprises receiving, through the buyer page, an image as a portion of the commodity description. The image may be a video.

In one embodiment, the method further comprises the steps of sending the commodity description to an expert-operated computer, and receiving valuation information from the expert-operated computer based on the sent commodity description.

In another embodiment, the method further comprises the step of displaying, through the buyer page, is an incentive value based on a purchase price. In one embodiment, the method further comprises displaying, through a dashboard page, a plurality of informational messages. The plurality of informational messages may comprise shipping alerts and warnings.

In one embodiment, the method further comprises the step of generating a payout offering sheet based on the municipality attribute of the buyer-operated computer. In another embodiment, the method further comprises the step of retrieving a tracking number from the shipping provider, and displaying, through the shipping page, the tracking number.

### DETAILED DESCRIPTION OF THE INVENTION

For the purposes of this disclosure, the term user refers to an authorized user of the system or method that will be buying a commodity from a customer (or seller). Users may include administrators and managers which have elevated rights and privileges. The present invention surpasses the prior art in many ways. For example, the present invention also allows users to make more accurate determinations of the value of a commodity through the assistance of an expert (such as an in-house valuation expert, or third party expert). In another example, the present invention can verify the identity of a customer with law enforcement databases or within internal databases.

In one embodiment, the systems and methods of the present disclosure supply retail operations with the ability to buy commodities (such as gold, silver, and platinum) from customers. The present invention provides opportunities for retail operators to properly buy commodities without a broker. For example, retail operations that may use the present invention include check cashiers, payday loan companies, jewelry stores, or any other high traffic retail location. In another embodiment, the systems and methods assist companies in obtaining the necessary license applications needed to operate a commodity (such as gold, silver, and platinum) buying business. In one embodiment, the systems and methods of the present invention may provide the user with examples of correctly submitted license applications, blank application forms, or automatically created forms. More than one form may be presented, for example, forms for each municipality in which business will be performed.

One embodiment of the disclosed methods further comprises the step of providing employees of the retail operation with training on how to validate the legitimacy of a presented commodity. For example, validation can be performed by using electronic gold, silver, and platinum testing equipment. In another embodiment, the method may further comprise connecting to a central network in order to validate the commodity. For example, the retail operation may connect to a central server over the internet. A camera at the retail operation may capture images of a commodity and transmit those images to an expert at the central server. The images may be captured by a webcam. A two-way communication may be established between the expert and the retail operation. In this way, the customer and user will benefit from the expert's knowledge regarding valuation.

The disclosed systems and methods may continuously retrieve live prices of a commodity from a known source. For example, the disclosed systems and methods may connect to a live gold, silver, and platinum feed from the New York Mercantile Exchange. Other feeds may be used, such as the London AM or PM fix. Likewise, other commodity-specific feeds may be used for other commodities (e.g., diamond price feeds, copper price feeds, etc.) In doing so, the disclosed systems and methods allow the retail operations to set what percent of the spot price they would like to pay. Retail operations may be able to set different pay outs for different locations. The feeds may be accessed by the system through an API, or the feeds may transmit information to the system at predetermined times.

The disclosed systems and methods may involve calculating the amount to be paid for different karats of gold, silver, and platinum (or other types of commodities) based on the predetermined percent of a spot price. For example, there may be optional percent increases set by the company that allows retail operations the ability to increase the original amount offered to the customer. The system has an optional employee incentive point system. For example, the system may give the employee a “point” for every dollar paid out. In another example, an incentive may be given at certain milestones. When the system is configured to allow the user to increase the buy price, incentives for the employee may be decreased if the buy price is increased. For example, for every additional dollar the employee offers for a commodity, a “point” may be deducted. Therefore, the incentive system makes it beneficial for the user to keep offer increases as low as possible.

The company determines what benefits the points equate to. For example, points may be redeemed for days off, cash, merchandise, etc.

If an offer is accepted by the customer, the user enters the customer's identification which is checked with a live Office of Asset Management and Control (“OFAC”) feed which checks the customer's name against a terrorist and drug traffickers list. A transaction number is generated that identifies the user that made the purchase. When the customer leaves, the user places the commodity (here, precious metals) in a security bag and seals it with a copy of the receipt. Different municipalities have different holding periods in which the commodities, such as gold, silver, and platinum, must be held. In one such example, the number of days that gold, silver, and platinum needs to be held is inputted in the system by the company. When the holding period is met the system notifies the user that the gold, silver, and platinum is able to be shipped. Holding periods may vary on a location basis (e.g. per municipality). The system can automatically e-mail or fax law enforcement of the purchases on daily or weekly basis. In addition, a third party API may be used to send this information to law enforcement. Some municipalities require a picture of the customer, a picture of the items purchased, a finger print, a copy of the seller's identification, a signed copy of the receipt. They can require none of these or some combination or all can be required. The present invention may use devices to capture all of these potential requirements and then store them in the software for future purposes if needed.

In one embodiment, the software may be configurable to hold a static purchase price for a commodity. The static purchase price may be limited to certain municipalities so that other municipalities may enjoy a fluctuating price. The type of unit measurements for the commodity may also vary by municipality. The software may be configurable to select the proper type of unit measurement based on the municipality.

One embodiment of the disclosed systems and methods can be described as a website for buying and selling gold, silver, and platinum. A username and password is requested by the website to identify the user. The username may be an email address or a user-selected user name. In one embodiment, the website may allow a user to retrieve their password if the password was lost or forgotten.

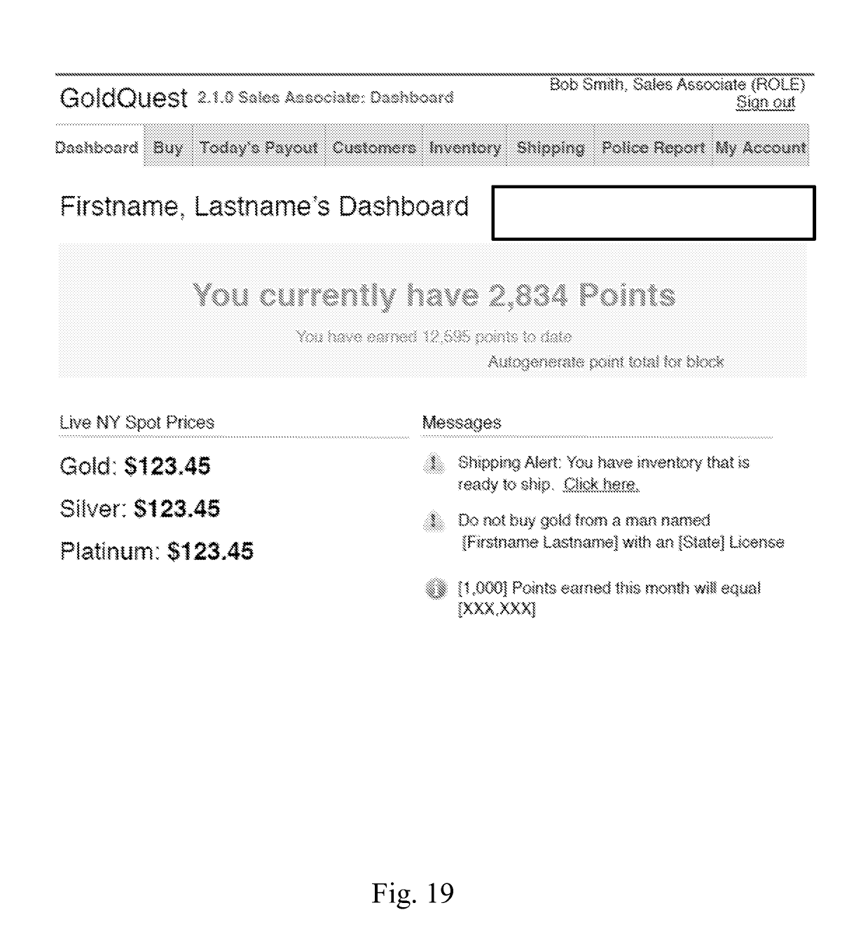

Upon logging in, the user is presented with a dashboard. One example of a dashboard is shown in FIG. 19. The dashboard may be personalized for the user. For example, it may display the user's name and title. The dashboard may present live spot prices for various commodities (e.g., gold, silver, and platinum). The dashboard may also present messages for the user. Some messages may include shipping alerts, warnings about which customers to not buy or sell commodities to, and a statement of any reward points earned. The dashboard may include a navigation bar that allows the user to navigate to different parts of the website. For example, the user may be able to navigate to a “buy” page, a “payout” page, a customer list, an inventory, a shipping list, a police report list, and an account configuration page. These pages will be discussed in further detail below. The pages may also take the form of reports. These pages/reports may be accessible based on permissions granted to the user. For the purposes of this disclosure, the terms “pages” and “reports” will be used interchangeably. The user may be able to log out of the software at any time. In one embodiment, the user will be required to log out and log back in after the completion of a transaction. In another embodiment, the user may be forced out of the software (and thereby required to log back in) after a certain amount of time of inactivity.

The account configuration page will allow the user to change their account settings, including their password. Other settings, such as the user's name, location, title, and biographical information may also be changed. The user may not have rights to change all of this information. For example, the user may not be able to change their own title or name. Administrator accounts may be permitted to make these changes on behalf of the user.

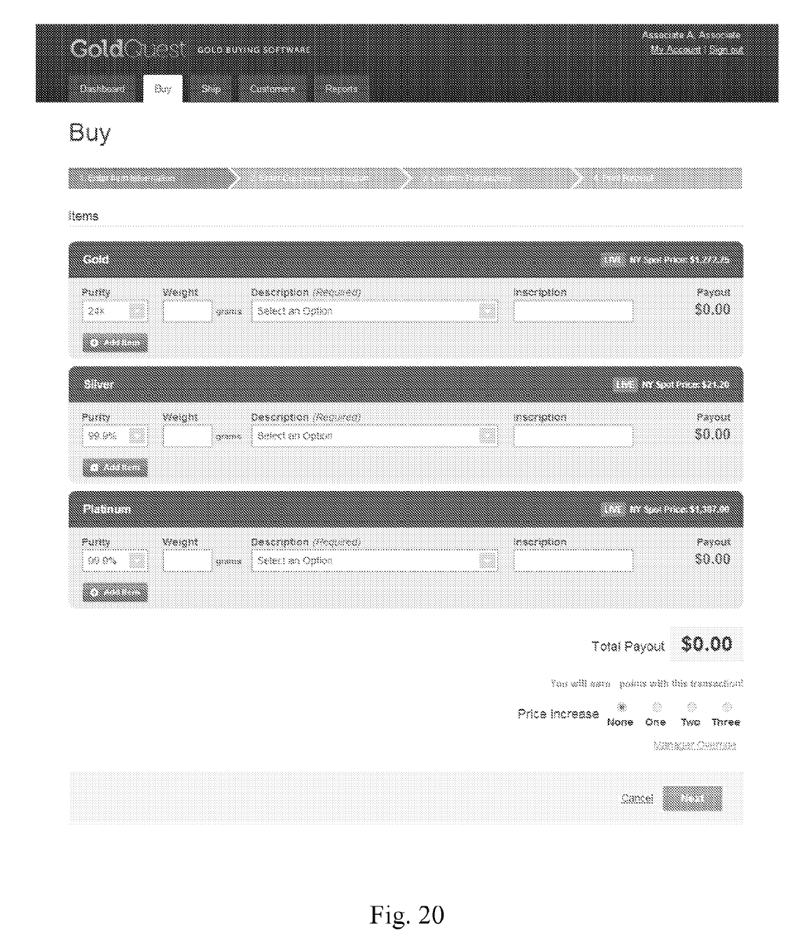

The buy page allows the user to enter item/commodity information that they will purchase from a seller. One example of a buy page is shown in FIG. 20. For example, the page may be separated into multiple sections. Each section may display a live spot price for the commodity. For example, a first section may be dedicated to gold. In this example, a user may provide the purity (8 k, 14 k, 24 k, etc.) and weight of the gold. Each section may require a description of the item being purchased. For example, a description may include “rings” or “rings with stones.” Additional fields may include any defining features of the item, such as inscriptions, serial numbers, manufacturers, etc. A payout breakdown may be provided to inform the user of the value for each of the described items. Additional commodities may be added to the buy page by the user or by an administrator.

The buy page may display a total payout based on the entered items/commodities. In one embodiment, the user may earn bonus points based on the transaction. For example, points may be calculated as a percentage of the total payout. In one embodiment, the points will be rounded down to the 10^{th} decimal place. An administrator may activate or deactivate this feature.

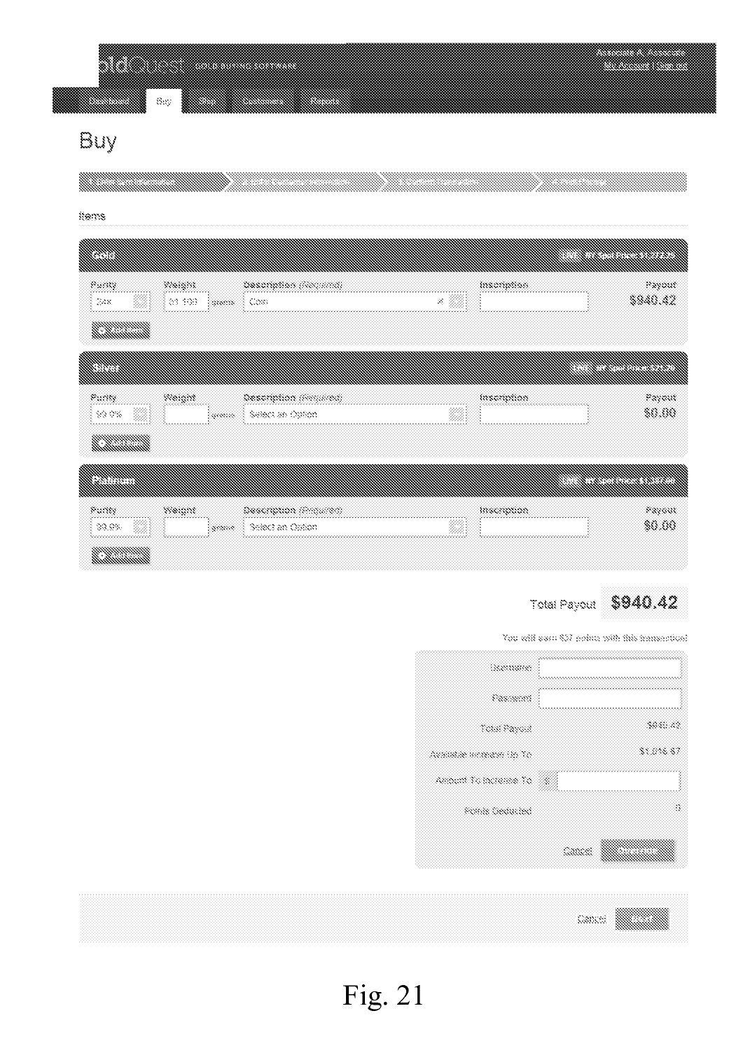

The buy page may also provide options that allow the buyer to increase their offered price. For example, the buyer may be presented with price increase buttons. In one embodiment, the buttons may be labeled “none,” “Level 1,” “Level 2,” and “Level 3.” Increasing the offered price may decrease the amount of points the buyer will earn with the transaction. Some levels of price increases may require an administrator or manager override in order to complete the transaction. One example of a page that allows an administrator or manager to override is shown in FIG. 21. In such an instance, the manager or administrator may be required to enter their username and password to complete the transaction. The manager or administrator may be able to increase the price for the transaction. In some embodiments, the manager or administrator may be limited such that a higher price may not be given. For example, the standard user may not be able to buy the commodity for more than 50% of the spot value of the commodity and the manager/administrator may not be able to buy the commodity for more than 75% of the spot value. Additional reward points may be deducted depending on how much the manager/administrator increases the payout price. In one embodiment, price increases may be suggested based on historical activity from the user. For example, a new user customer be given a more favorable price in order to entice the new user to transact more often. Or high-value customers may be offered a better price than low-volume customers.

The buy page will allow the user to advance to the next step or cancel the transaction. In one embodiment, the user will be able to cancel and flag the transaction. For example, a transaction may be cancelled and flagged if a customer cancelled the deal, or if the transaction was being performed for training purposes. The cancelled transaction may be archived. The user may be able to provide notes and reasons for cancellation that can be reviewed at a later time. This may be helpful in order to identify patterns by employees to prevent fraud, encourage better customer service, or track prices at which customers are more likely to transact with the buyer.

If the user advances to the next page, customer information will be collected. In one embodiment, the customer's photo may be collected. The photo may be collected by scanning a photograph (such as a photo in a license) or by capturing a picture using a camera or webcam. The photograph may be in black and white or color. In addition (or alternatively), the customer may be required to provide a fingerprint. The fingerprint may be scanned in using an electronic fingerprint reader in communication with the system. In another embodiment a fingerprint may be created using ink and paper. The paper fingerprint may be scanned in using a scanner in communication with the system. In addition (or alternatively), the customer may be required to provide a copy of an identification card, such as a passport or driver's license. A copy may be capture using the camera or webcam. Alternatively, a copy may be capture using the scanner. The user may be required to enter specific information from the identification card. For example, if the customer provides a driver's license, the user may need to input an identification number and state associated with the driver's license. This information may be auto-populated.

In one embodiment, customer information such as the fingerprints, photos, government IDs, etc. are uploaded directly to a third party provider, such as Leads Online, where required by local or state law. The upload is performed in the background and does not require any user input. Thus, the upload appears seamless from the user/buyer's perspective, and the user/buyer does not need to leave the software to perform this step.

The user/buyer may need to input additional information about the customer. For example, the user/buyer may need to input the name, address, and phone number of the customer. An ID number or license number may also need to be entered. If the customer is known to the system, the information may auto-populate. The user/buyer may also be required to input personal details about the customer such as height, weight, date of birth, gender, hair color, eye color, and ethnicity. The user/buyer may also be required to input information about any potential referral sources for the customer or additional notes. For example, the software may contain a referral program. The referral program may incentivize referrals by giving bonuses to the person or people that referred the current buyer. The bonuses may be a discount, gift, or other incentivizing item.

The information inputted by the user/buyer may be compared to a database, such as the OFAC. If there is a positive alert corresponding to the customer, that alert may be displayed to the user/buyer. An action spinner (or some other graphical element) may be shown to the user/buyer while the OFAC search is being performed. The user may be directed to the website (i.e. OFAC website) and asked to enter the information. In one embodiment, the search may be performed automatically, and then based on the result, the user may be asked to re-enter the information directly on the OFAC website. In another embodiment, the information is passed to OFAC in the background such that the user does not need to open a separate application or website to perform the OFAC search.

The user/buyer may then be presented with a screen to confirm the transaction. A summary of the commodities and their type may be presented to the user/buyer. Other fields may be presented as well. For example, purity, weight, description, price per unit, etc. may be shown. The user/buyer may have the option to go back and edit items displayed on this screen. If the user/buyer confirms the transaction, a print view may be created that contains the time and date of the sale, the customer information, and information of the buyer/user. This print view may be printed electronically (and signed electronically) or printed physically (and signed physically).

The payout summary page or report may include information on the total commodities purchased during the course of the day, week, month, or a user-defined time period. The commodities may be separated by type or purity. The commodities may also be separated by user/buyer or location.

A payout offering page may also be provided. The payout offering page may be automatically generated for municipalities that require a daily posting of commodities prices. The generate page may be displayed at the buyer's location as required by each particular municipality. The system may also track, categorize, and store historic payout offering pages. Historic payout offering pages may be correlated in other reports.

A customers page may also be provided. Customers may be added to a customer database. For example, customers may be added when a transaction is completed between a customer and a buyer/user. The customer page may allow a user to search for a specific customer. The search may be performed by identification number, first name, last name, or any other field in which customer data is stored. A user/buyer may be able to retrieve prior transaction data based on a selected customer. Transaction data may include a total summary to of a customer's history. For example, if a customer sold more than a predetermined amount a year, the software may provide an IRS form (e.g., 8100 Form) for the customer.

An inventory page may also be provided. The inventory page may display the total inventory value and a ready to ship/sell inventory value. These values may be based on an up-to-minute spot price for shipping insurance purchases. The inventory page may also display a “needed to ship” value. This value may be pulled from the administration panel. The “needed to ship value” may be sent to encourage fewer, more valuable shipments. In embodiments where a “needed to ship” value is displayed, a shipping button may only be visible (or actionable) after the ready to ship value is higher than the needed to ship value. The user may be able to select which transactions are ready to be shipped and which transactions need to be held.

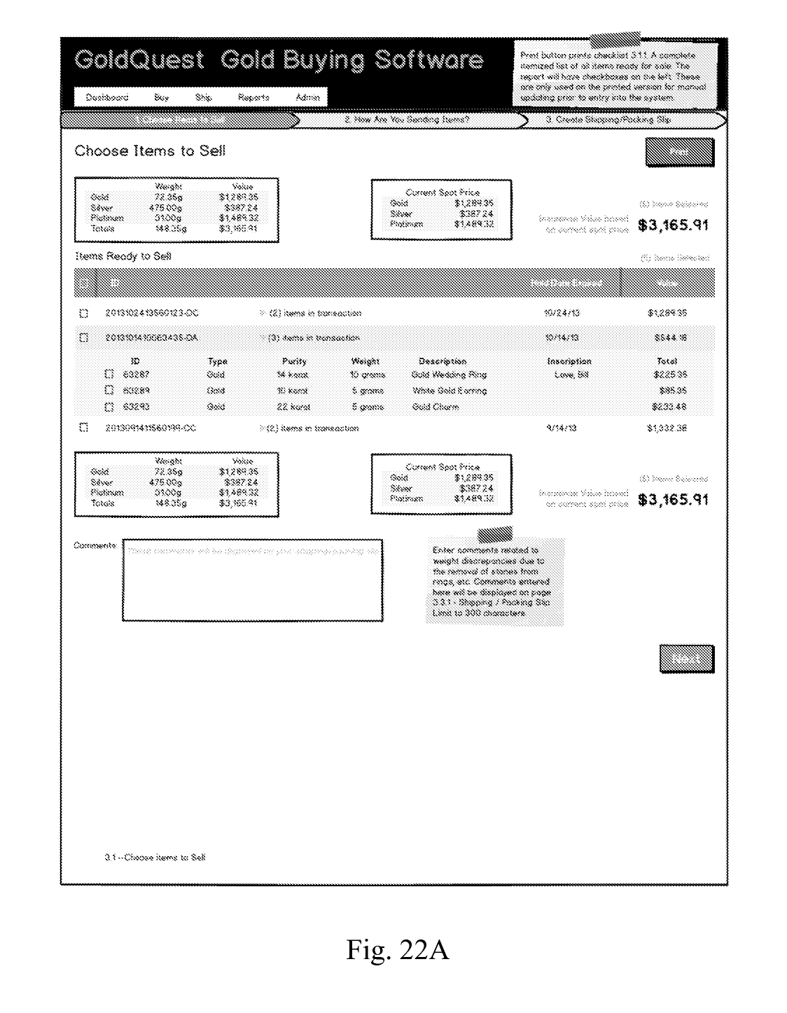

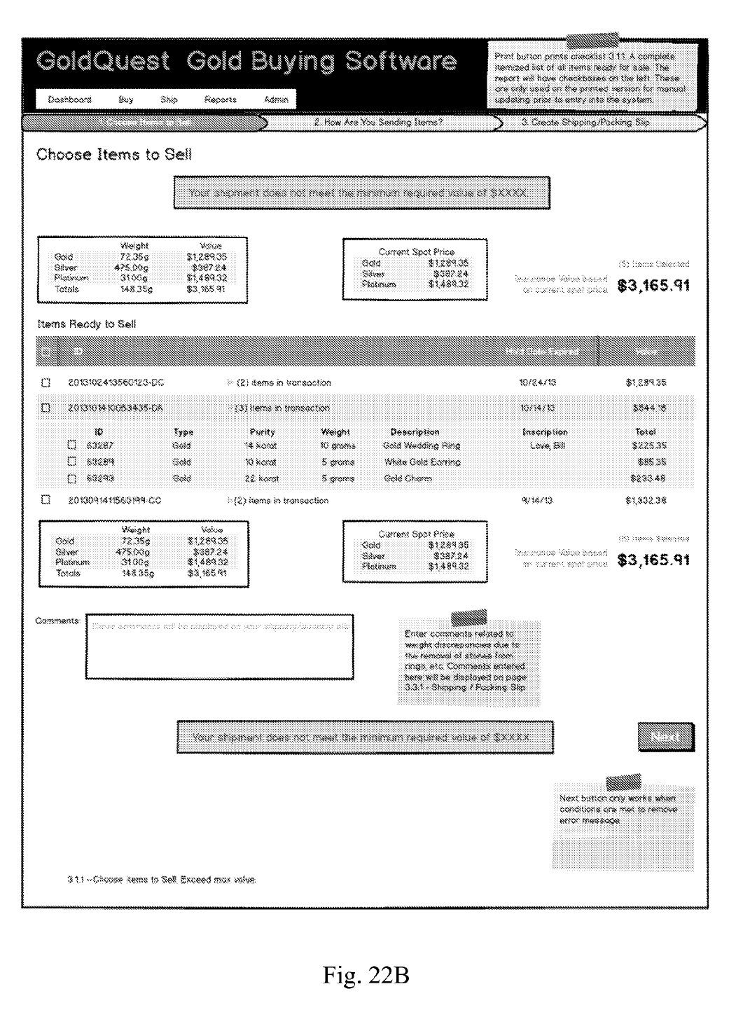

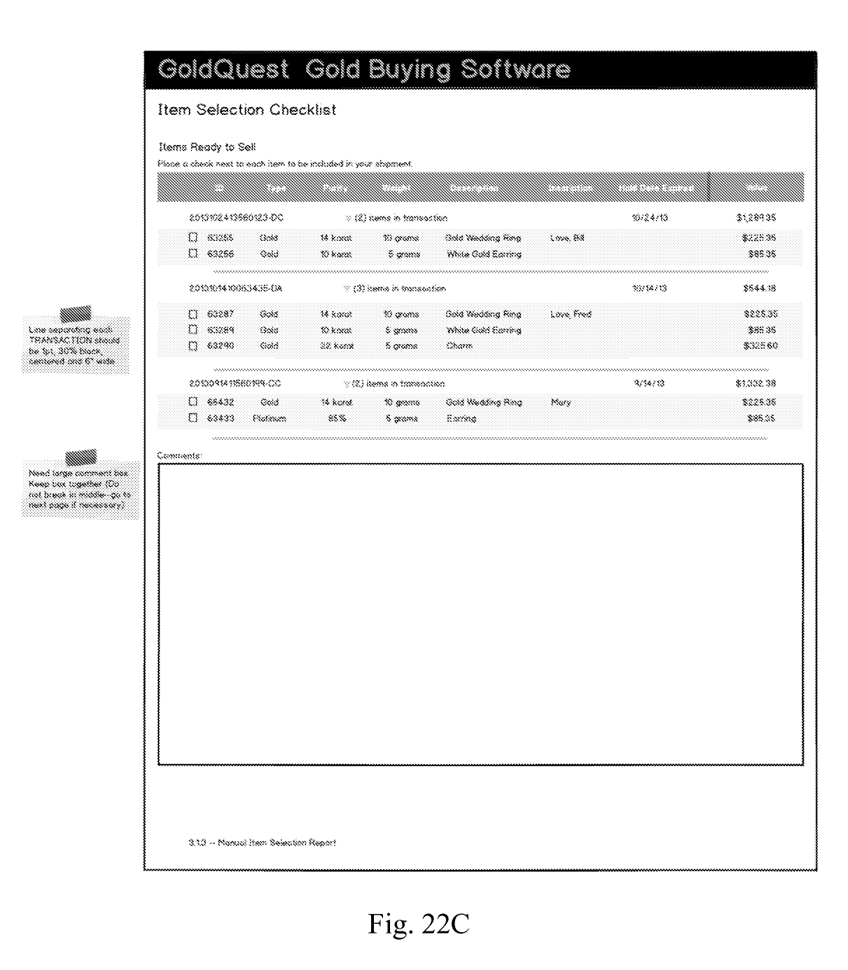

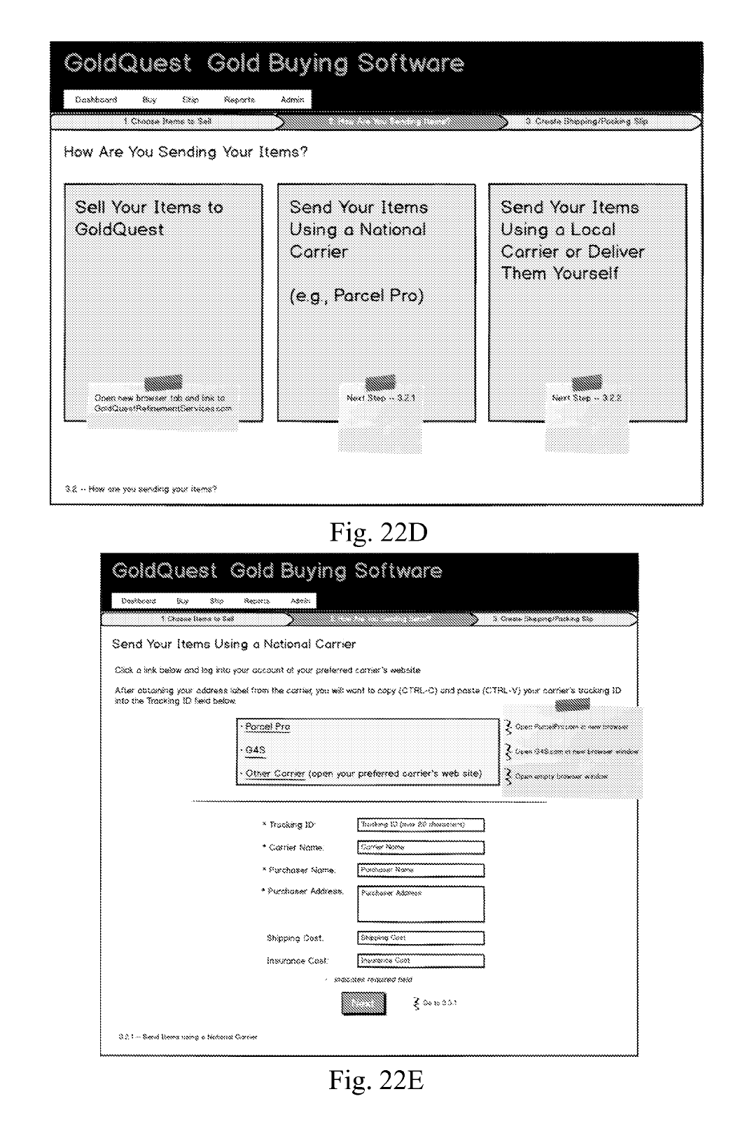

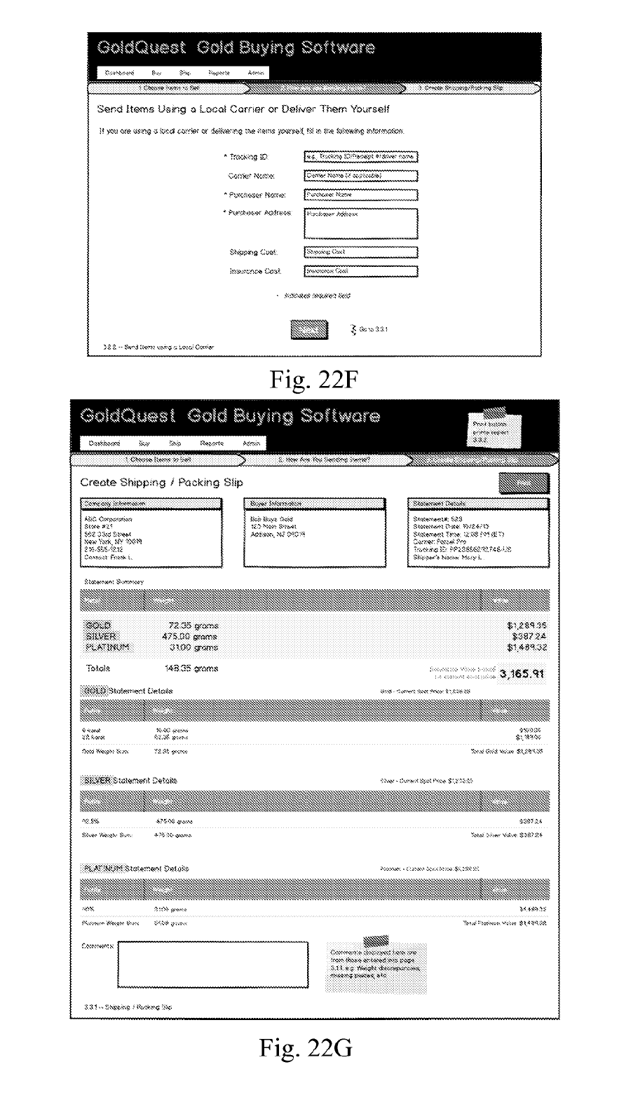

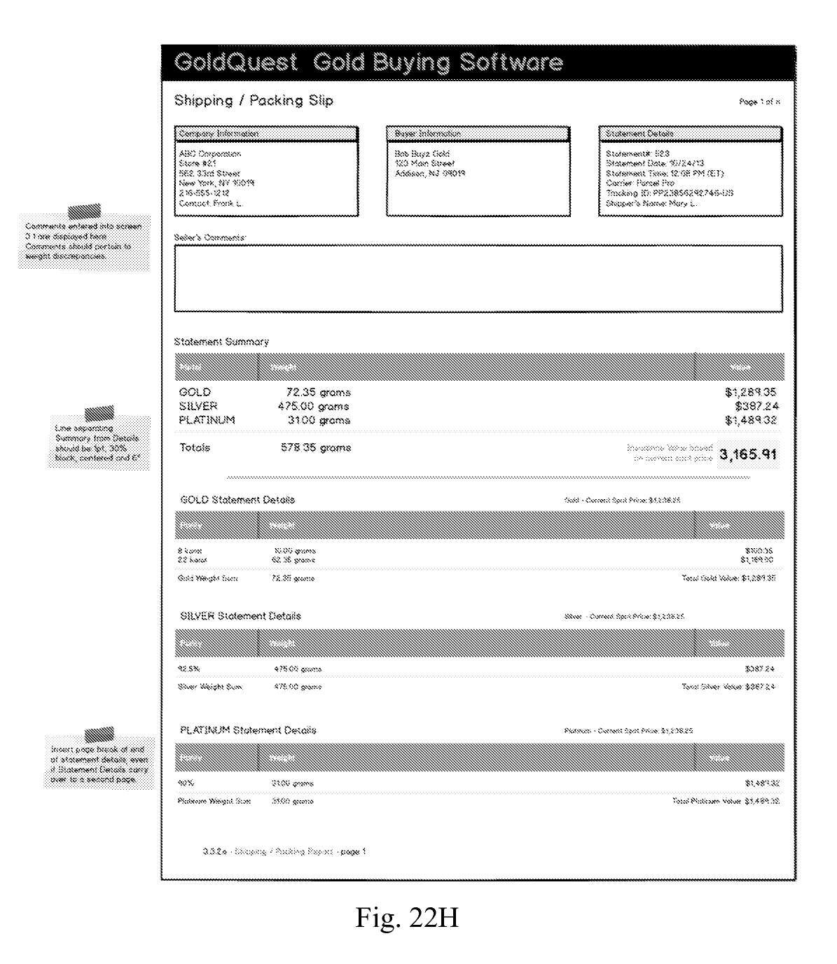

A shipping page may also be provided. One example of a shipping page is shown in FIG. 22. The shipping page may keep track of shipments of commodities sent. Each shipment may have a unique ID and a tracking number. The tracking number may correspond to a tracking number provided by a shipping company. Or, the tracking number may be separate from the number provided by the shipping company. A value for each shipment, shipping date, and shipping status may be presented for each shipment. A user may be able to drill down into each shipment for additional details. In one embodiment, a user can search for shipments. The search may be limited to specific dates or other filters. The shipments may be organized by status or any other field. In one embodiment, a shipping API may be provided that allows users to create shipments with a shipping provider. Insurance may be required for a shipment. The shipping API may instruct the user about what amount of insurance is required per company practice. As such, the amount of insurance may be set by the company. The amount of insurance required may also vary based on a number of factors, such as size of the shipment, destination, contents, and weight. A shipping request may be automatically generated. The user may be able to edit the shipping request as needed, or the shipping request may be unchangeable in order to deter fraudulent shipping requests.

A user may be able to create a shipment using the shipping page. In doing so, the user selects which transactions should be included in a shipment. The value of each transaction is added together to create a total. In one embodiment, the user may be prevented from creating a shipment with a total value over (or under) a predetermined number. This predetermined number may be set by an administrator. The user may be able to schedule a pickup by including a shipment date and time. In one embodiment, a shipping label may be printed with the entered information. The invention may also automatically tell the user which transactions can be shipped based on the regulations and time constraints for each municipality.

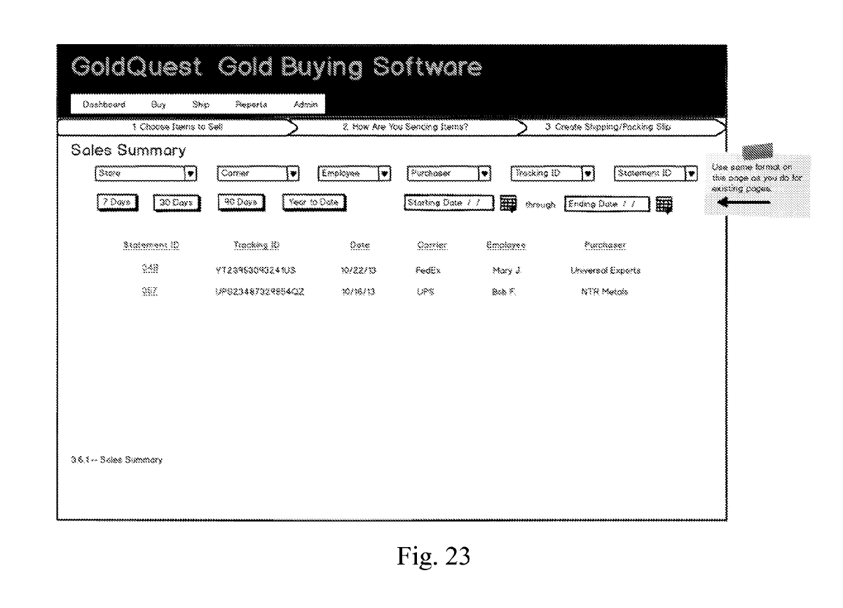

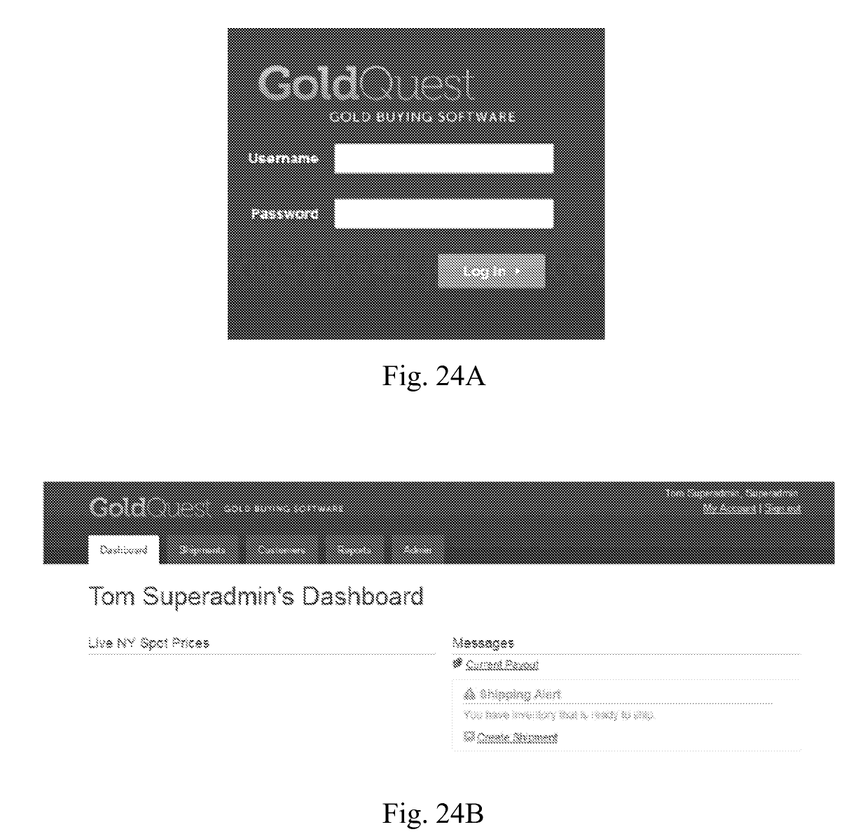

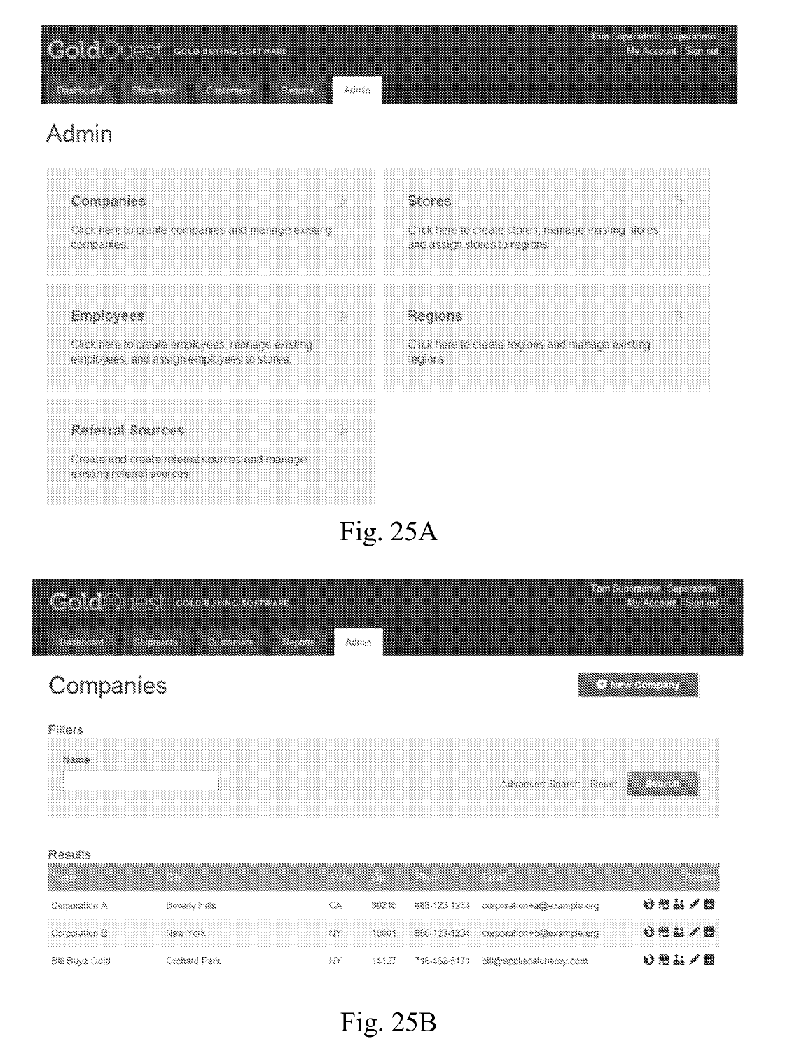

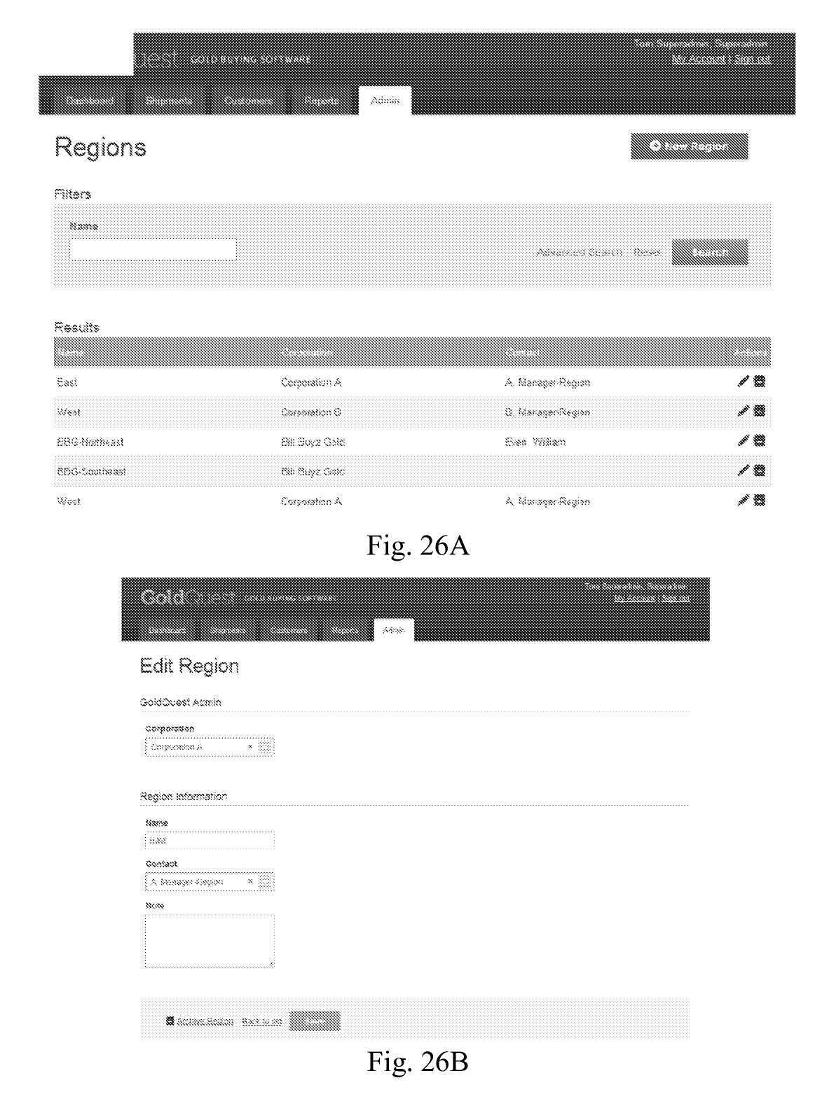

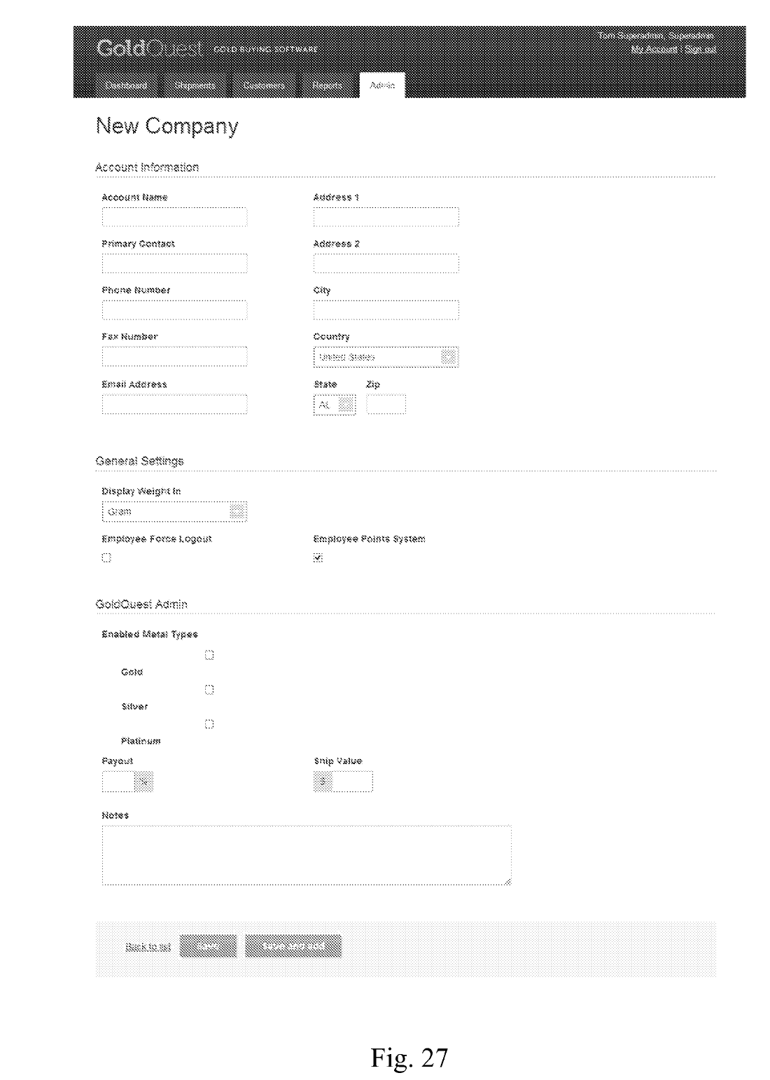

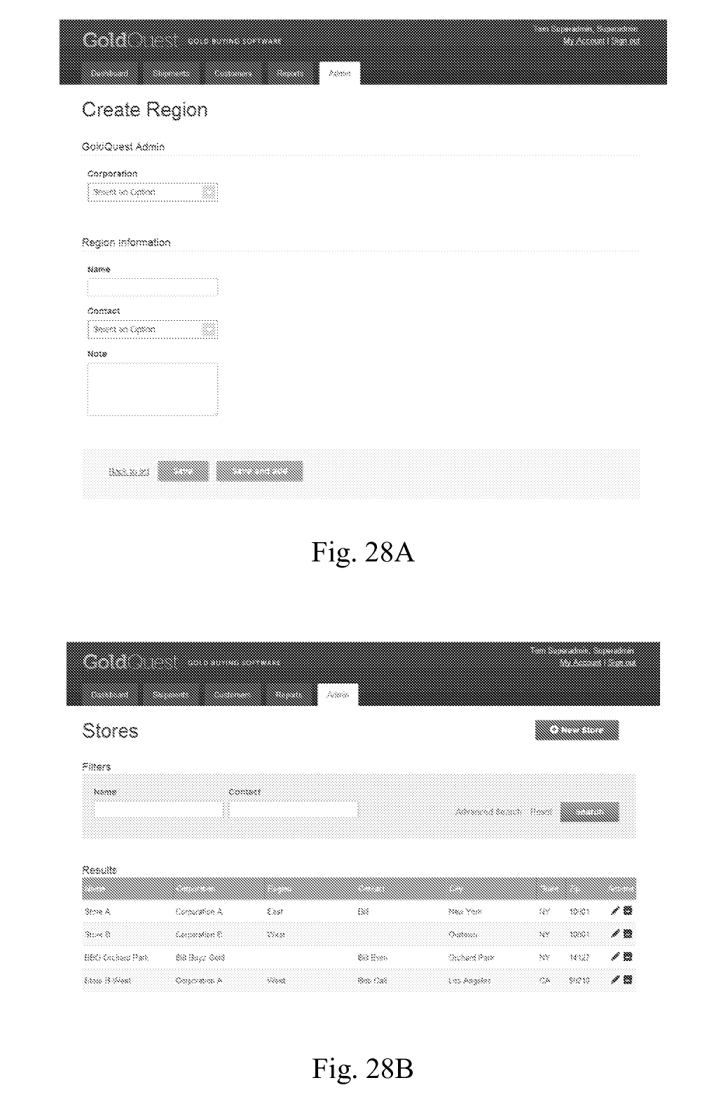

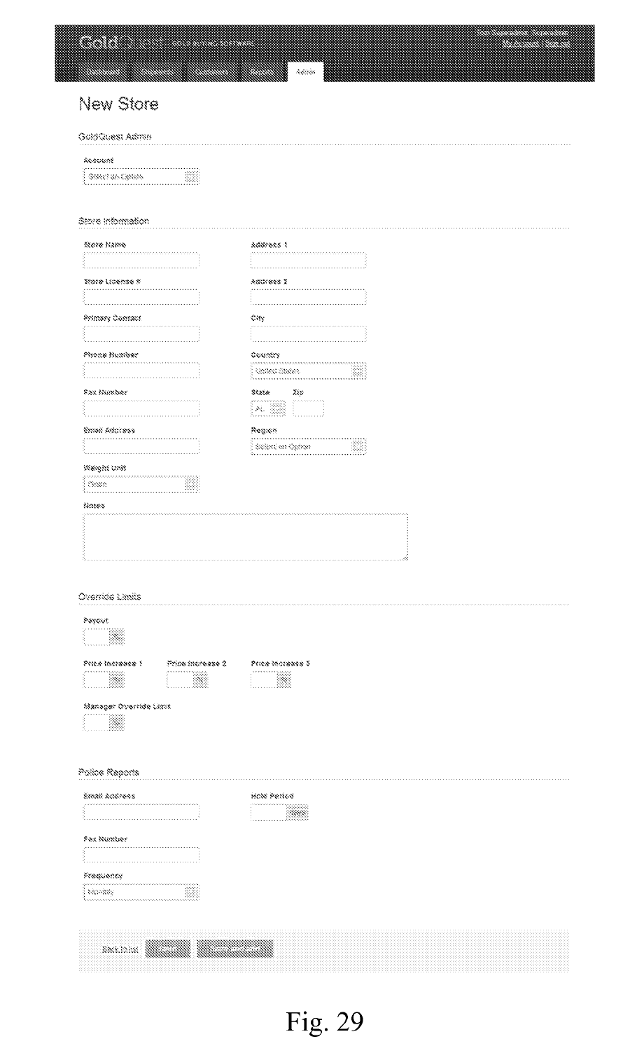

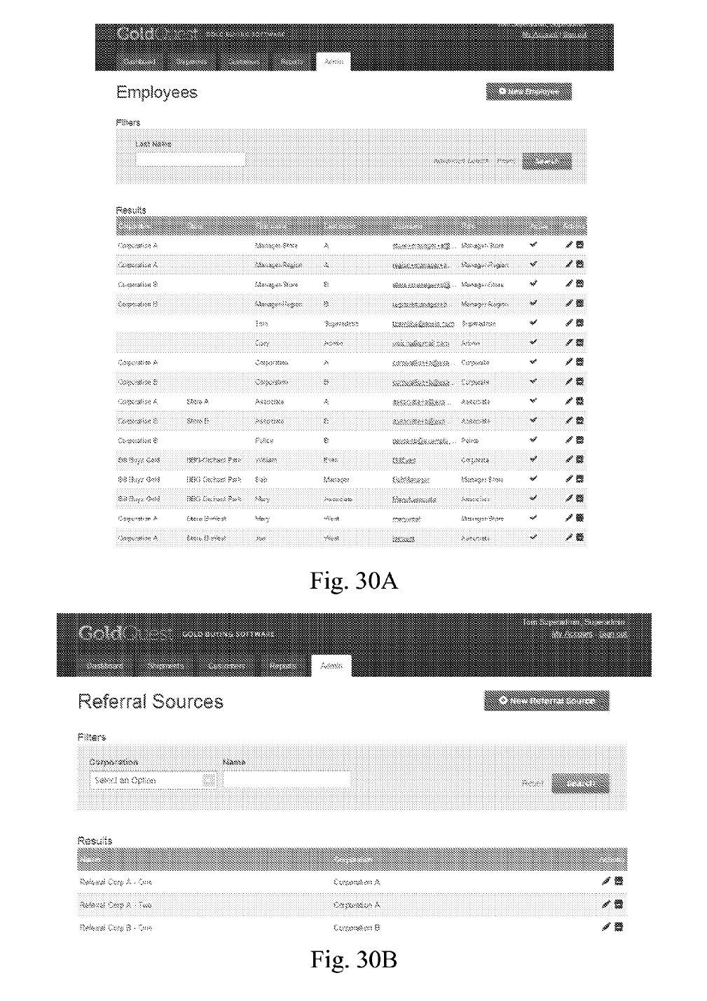

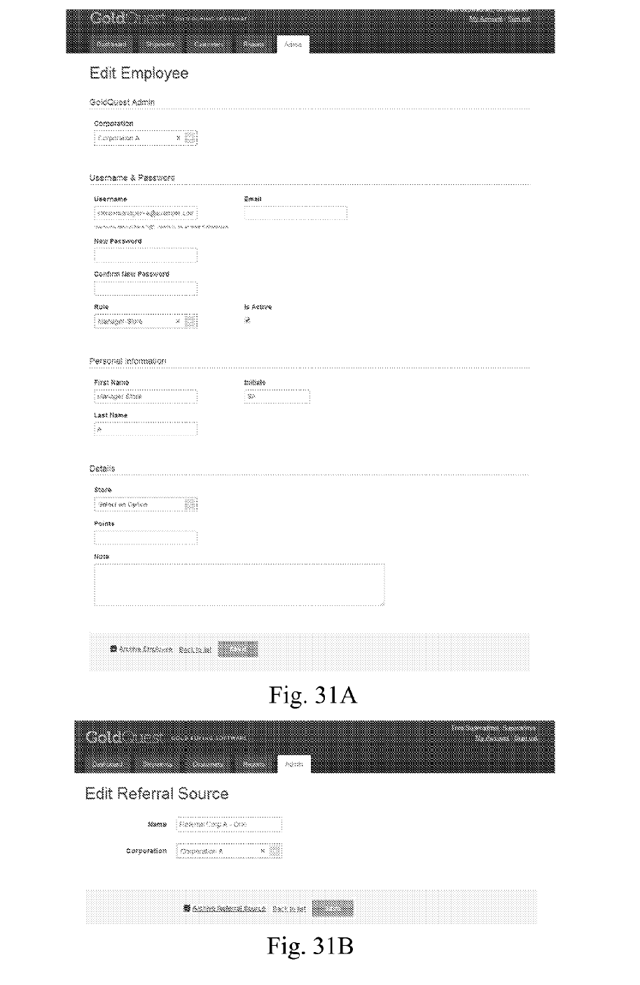

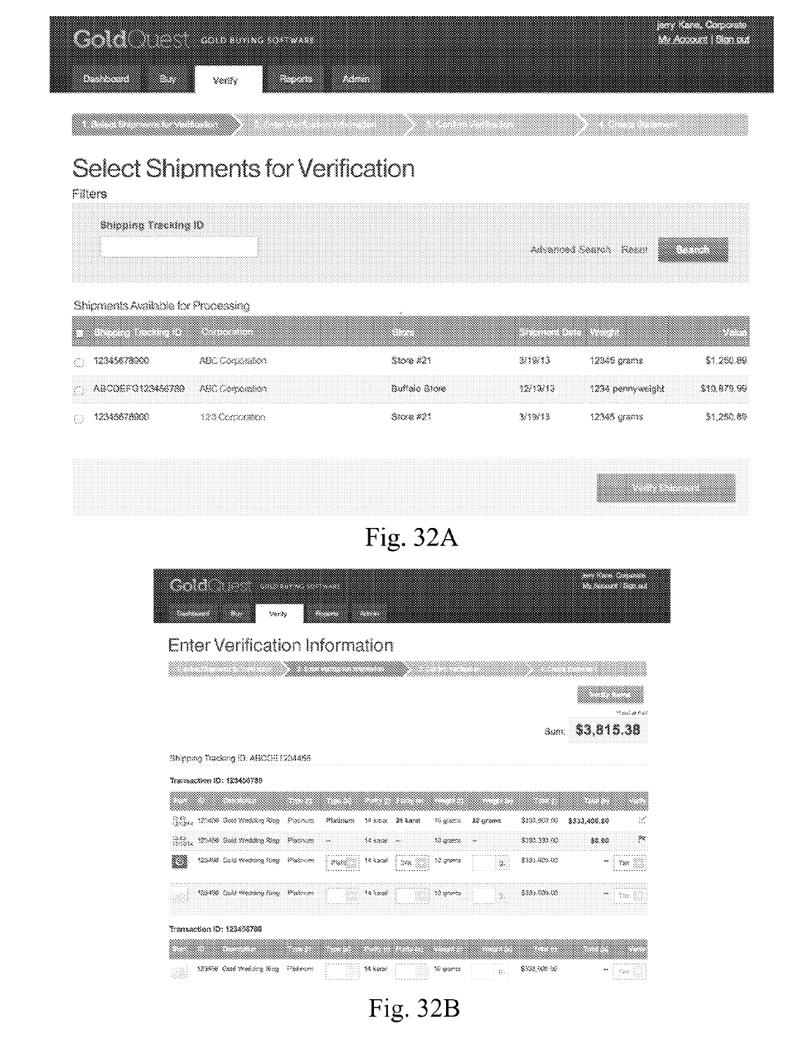

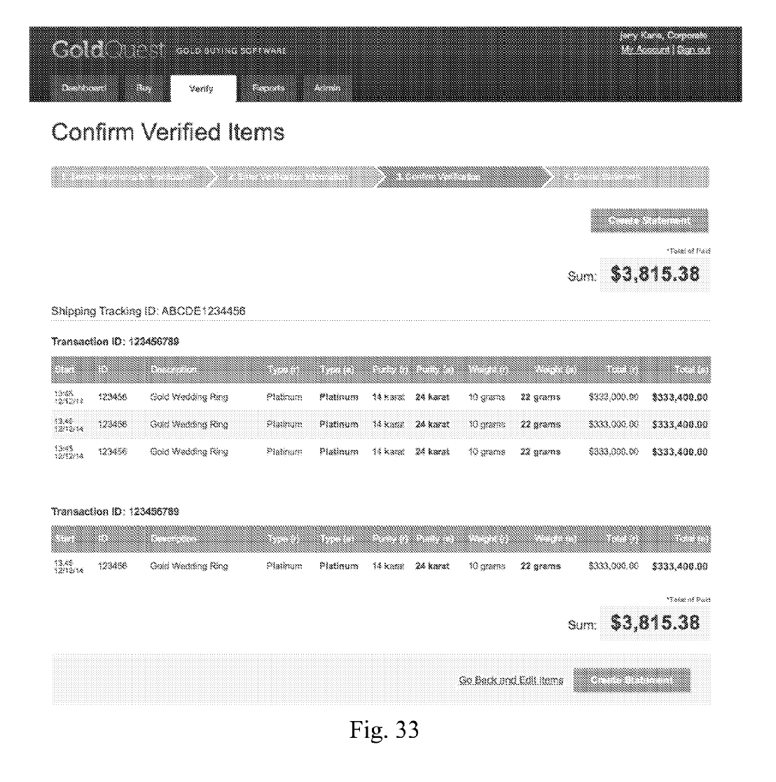

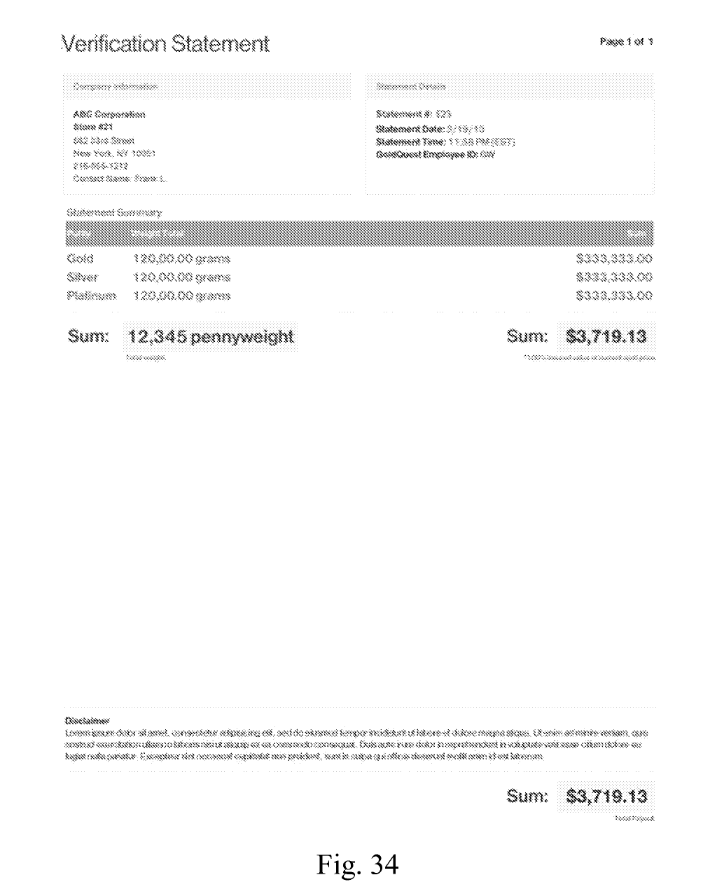

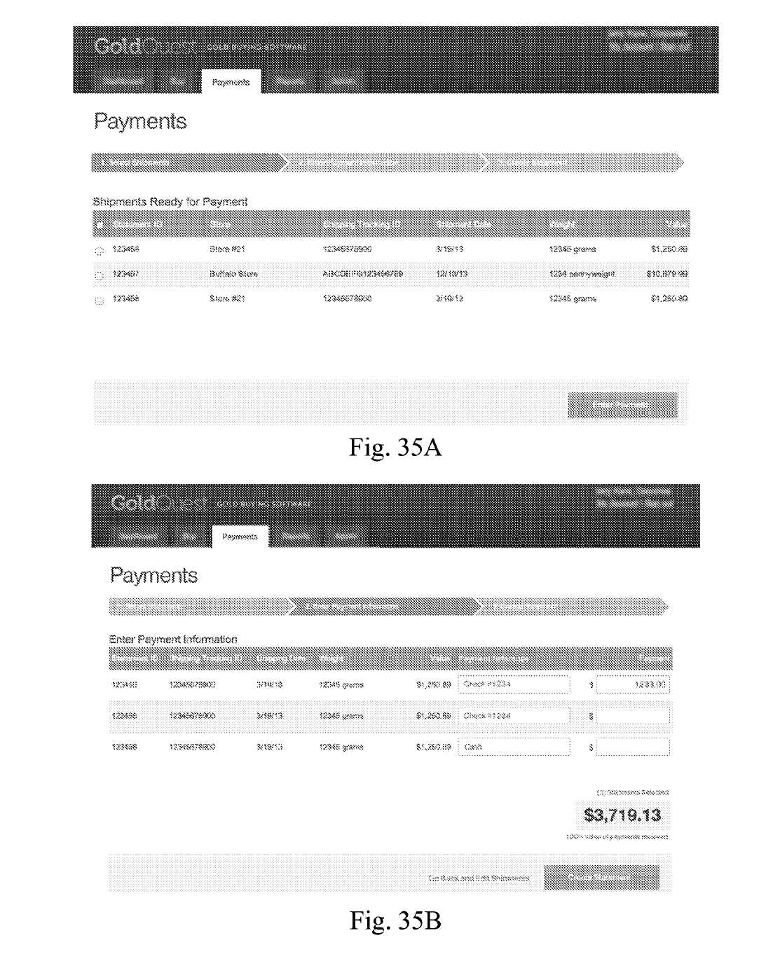

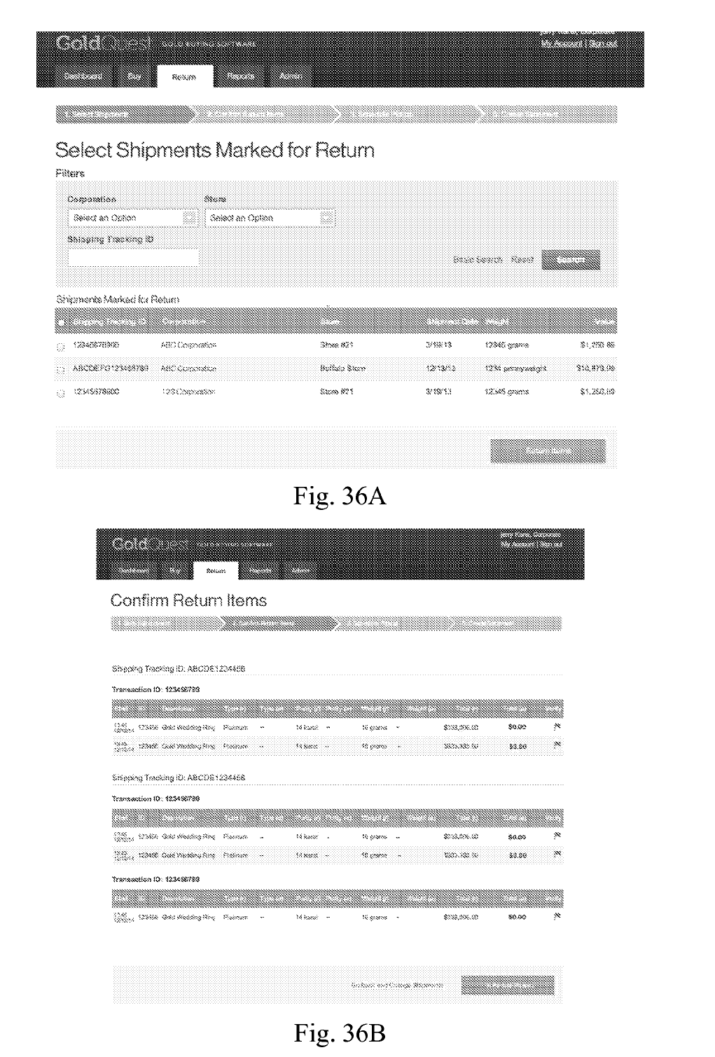

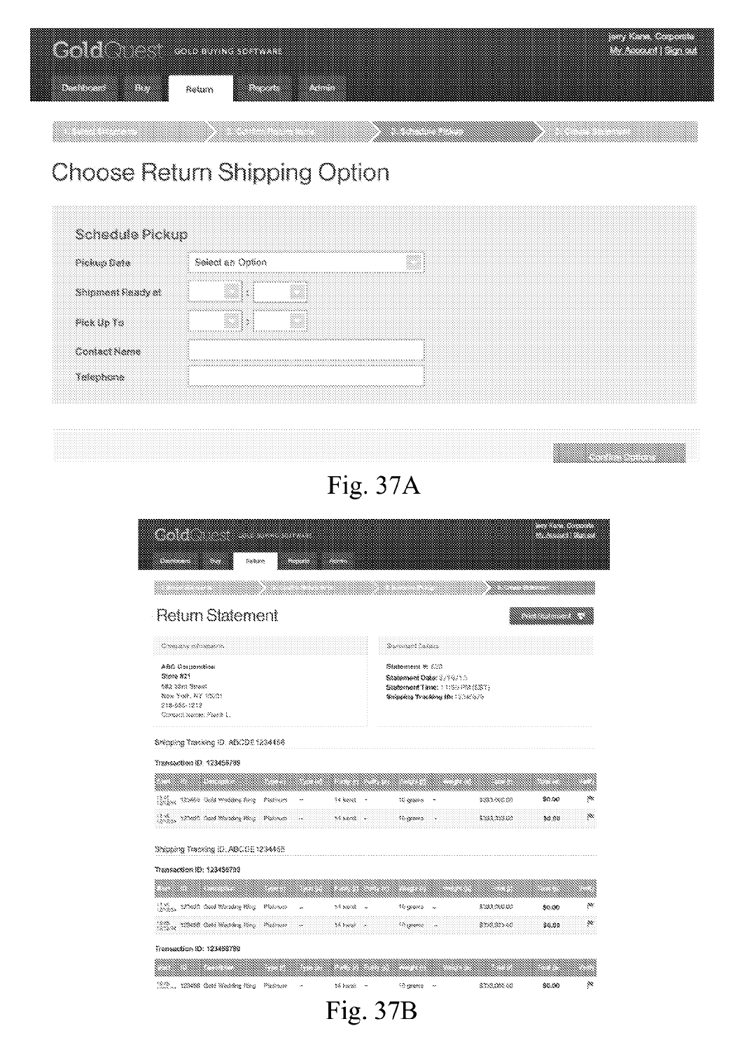

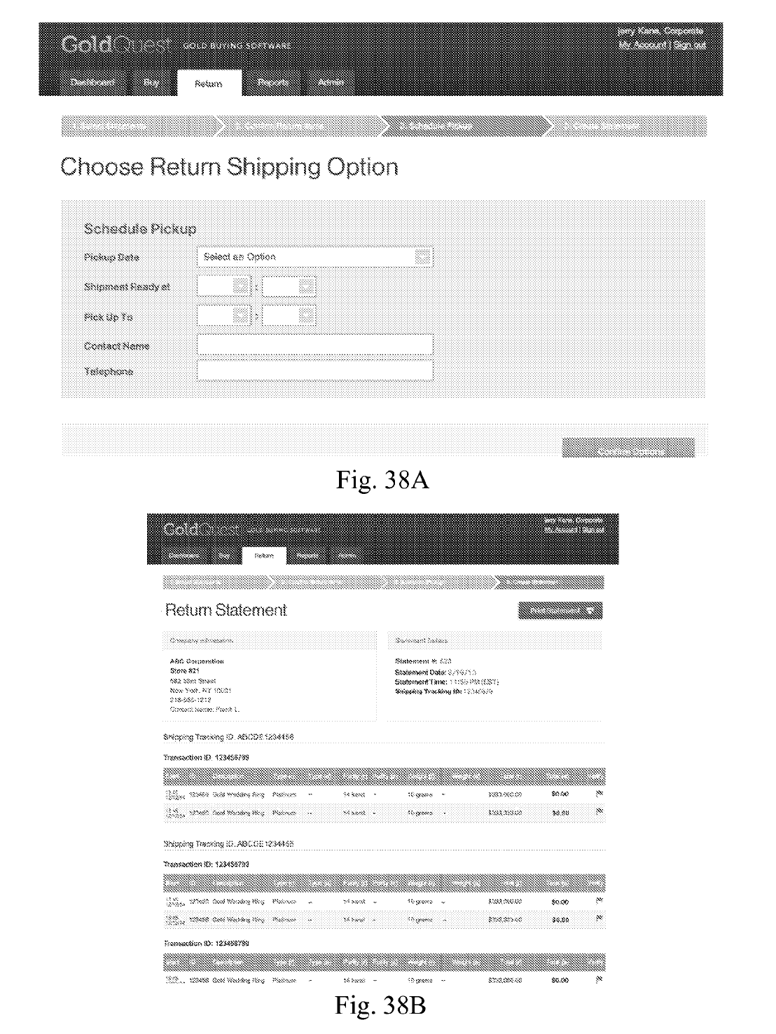

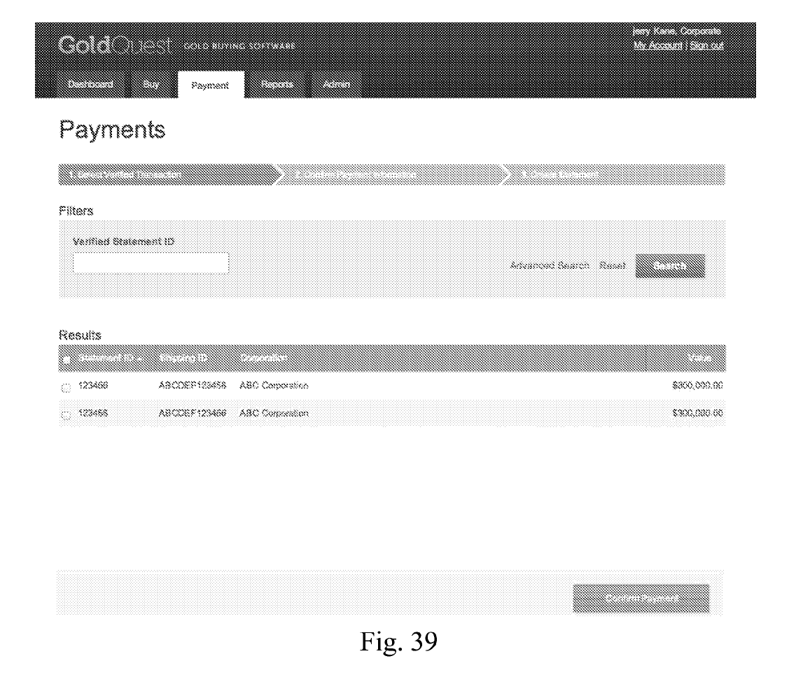

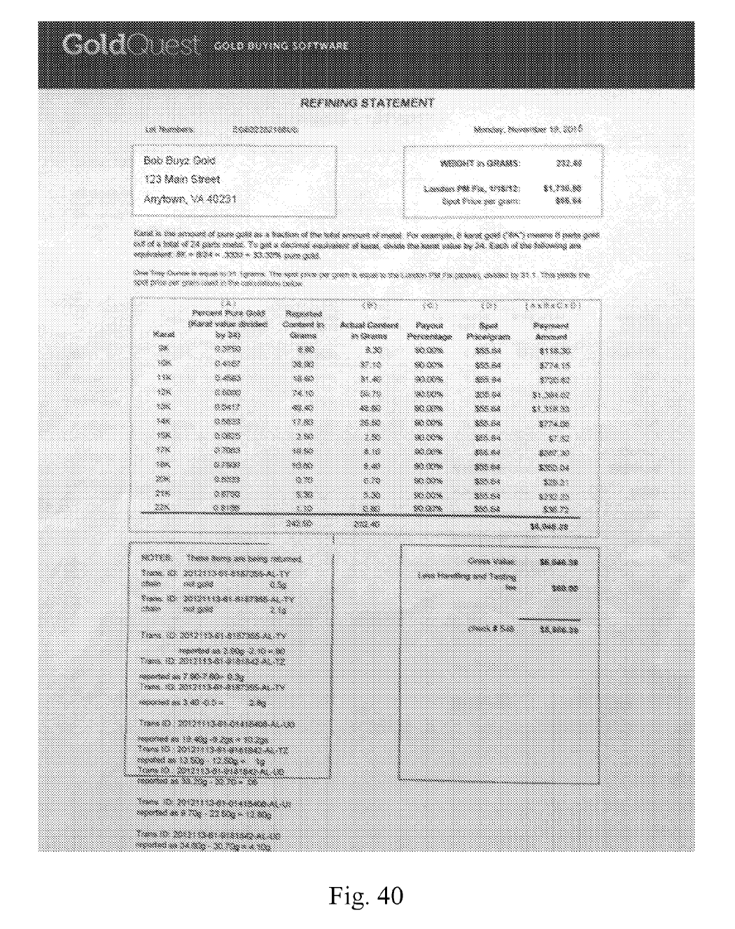

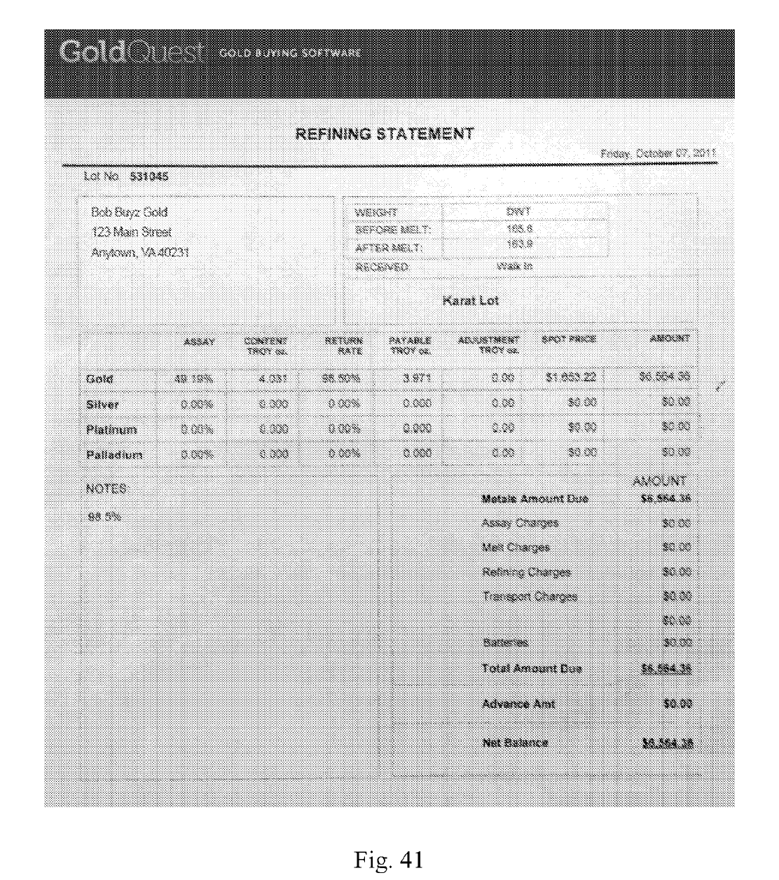

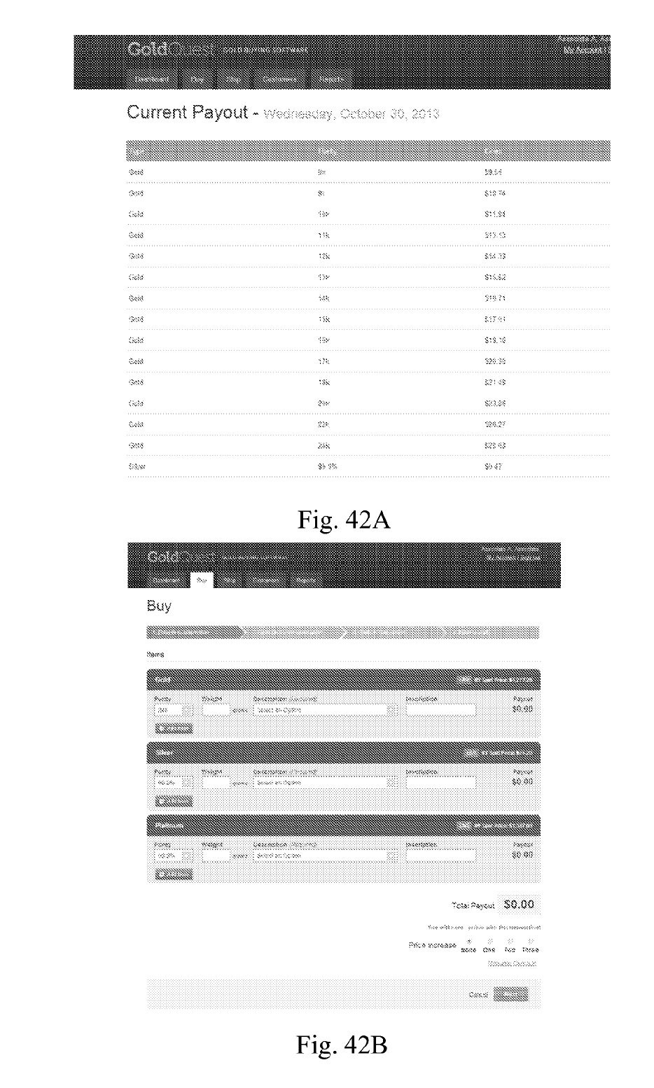

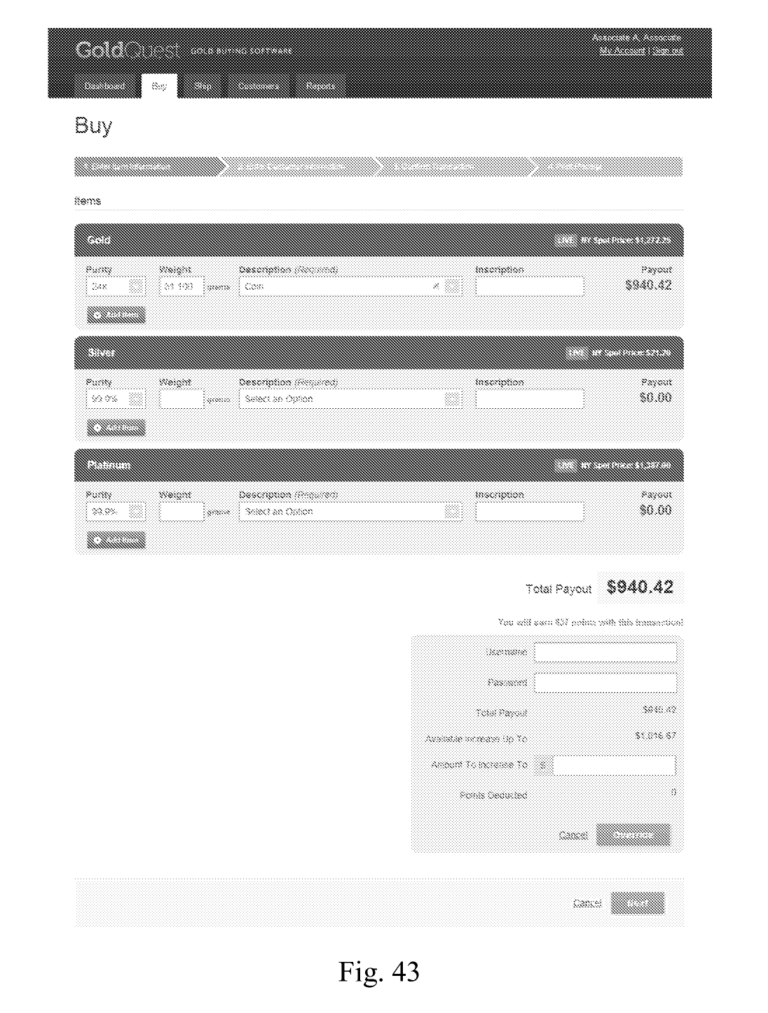

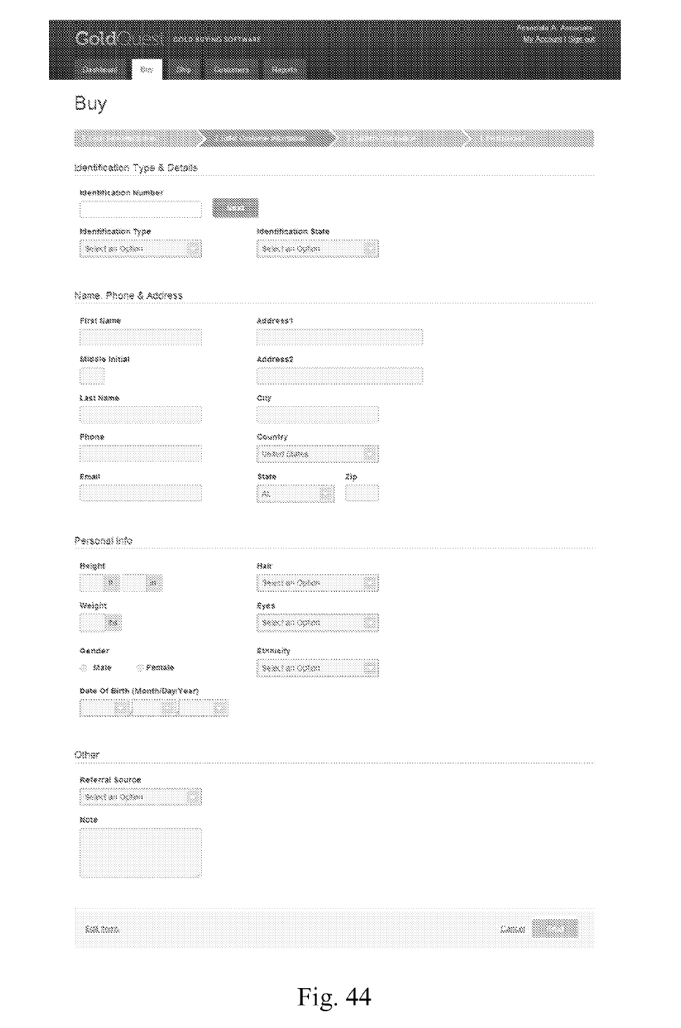

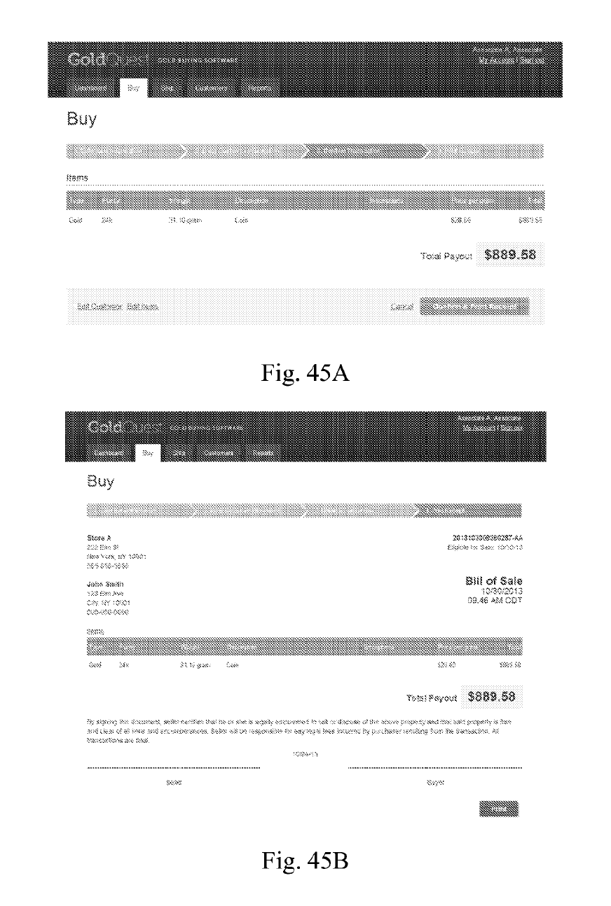

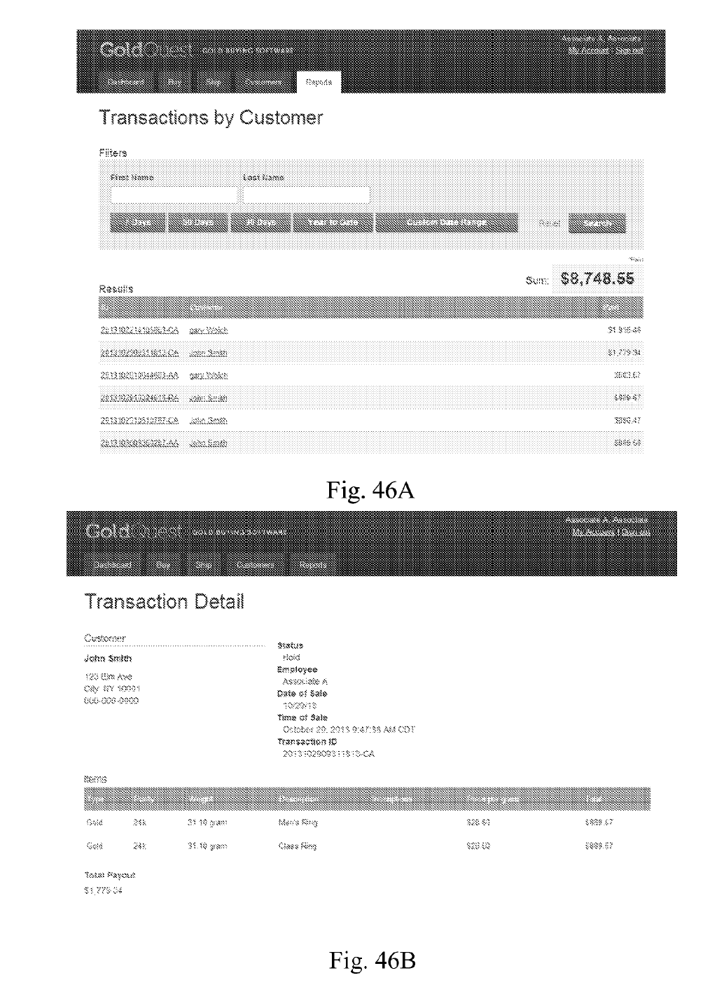

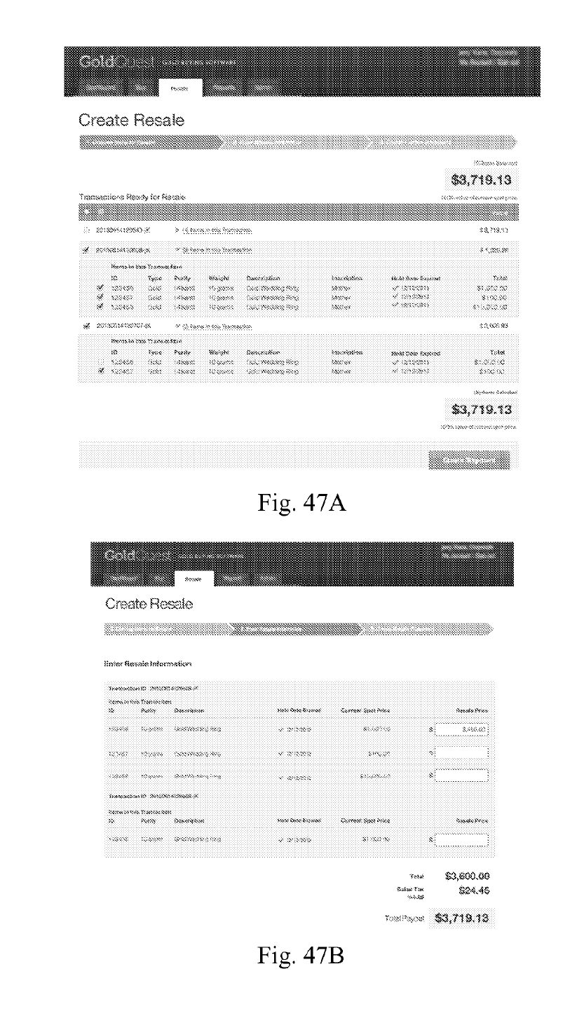

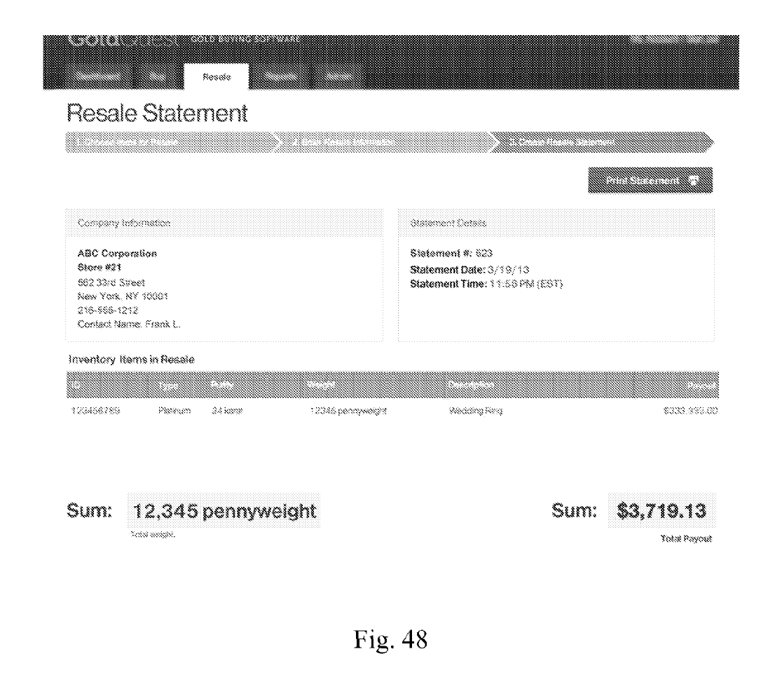

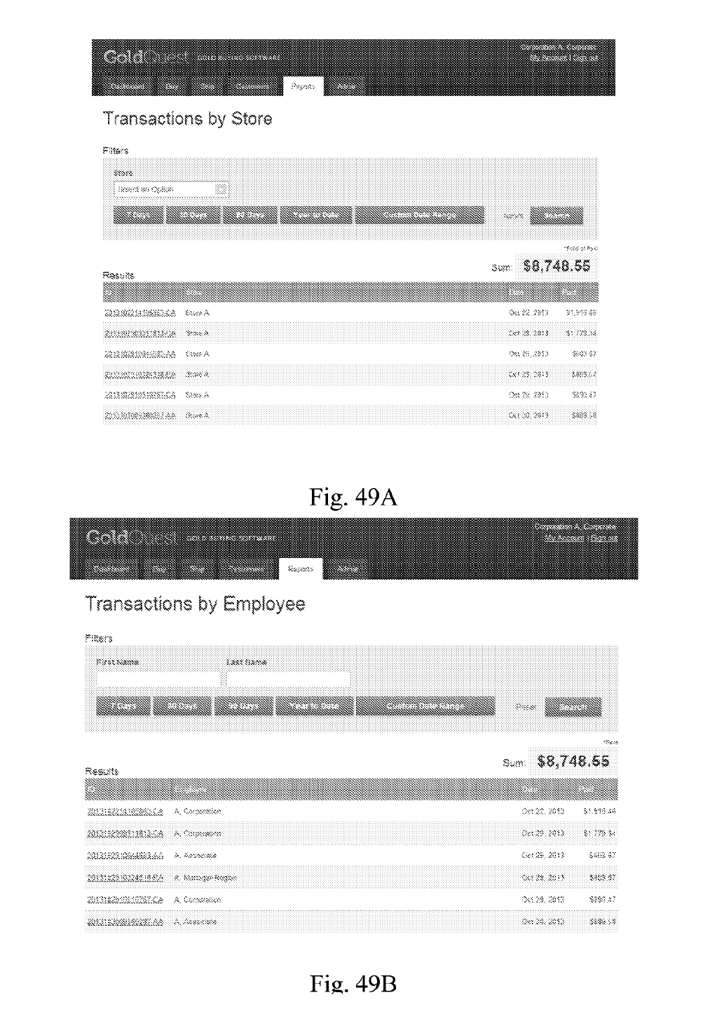

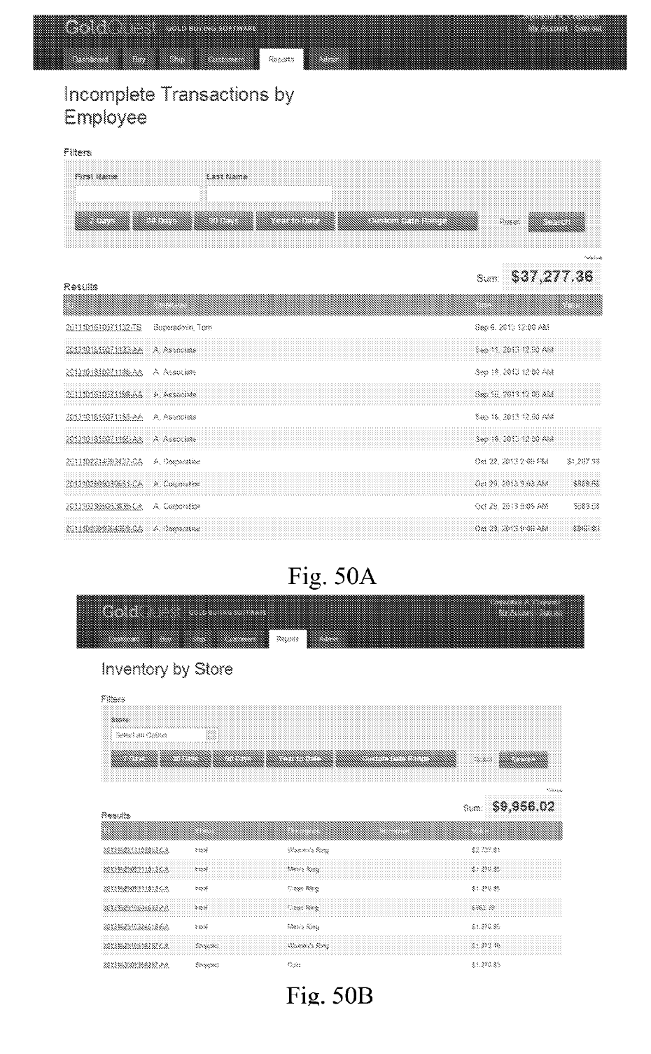

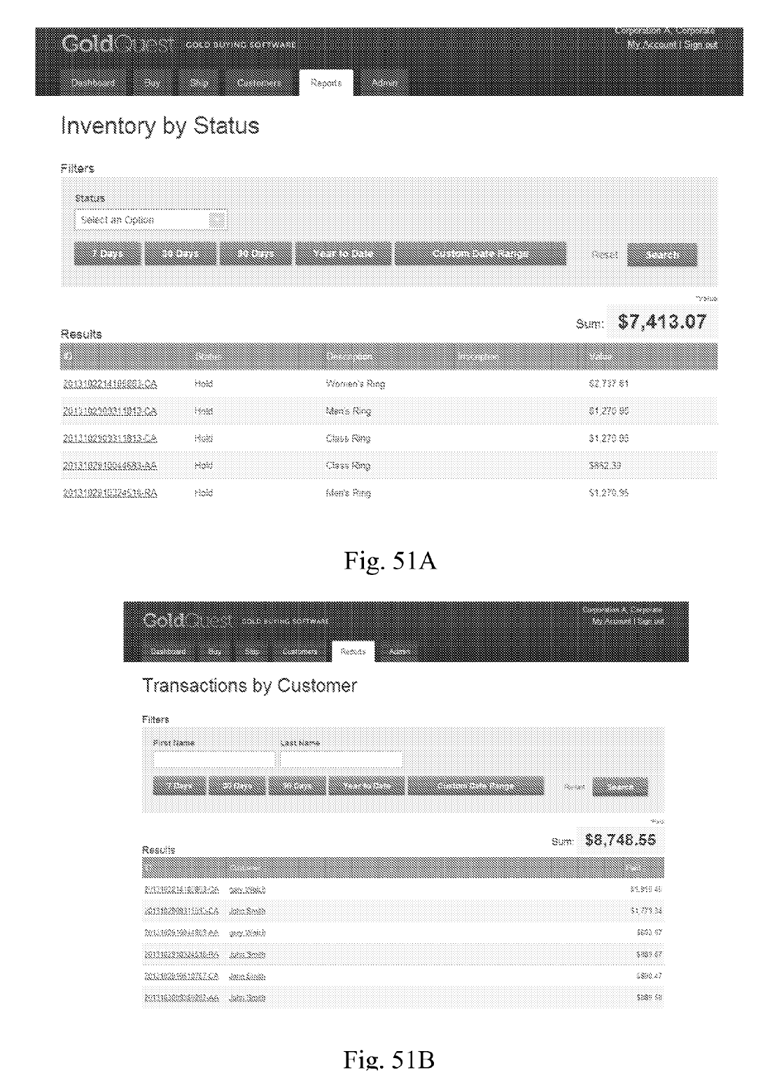

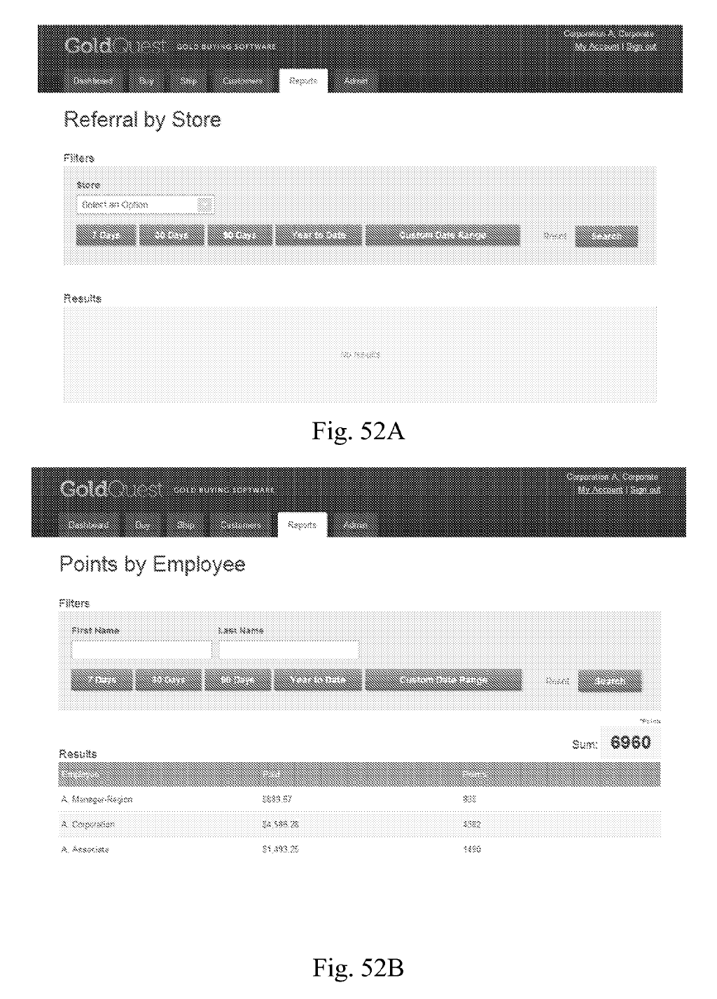

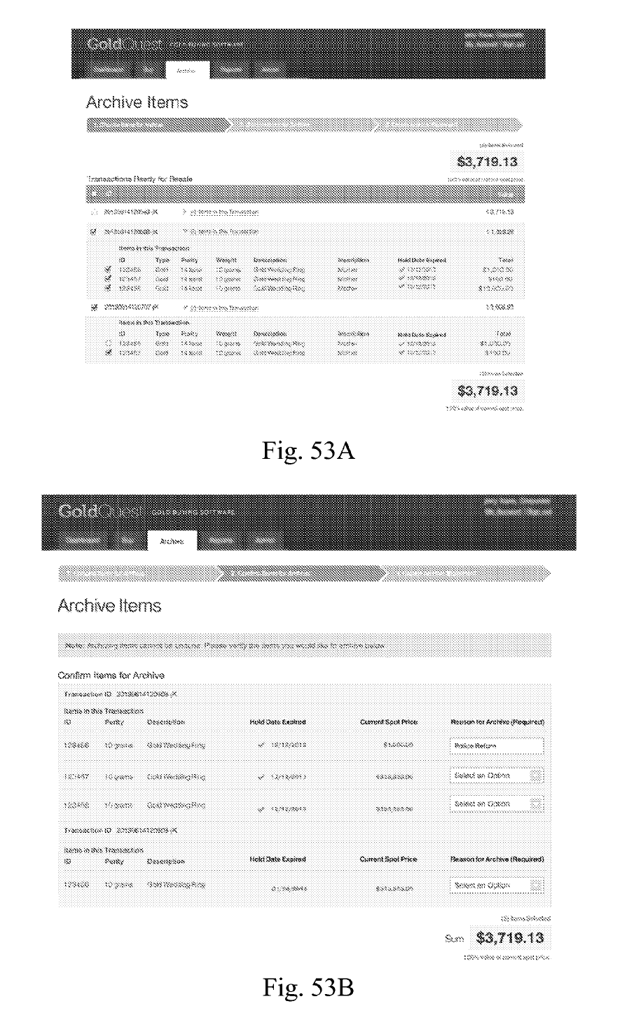

A shipping statement may be produced. One example of such a shipping statement is shown in FIG. 23. The shipping statement may contain the buyer's information (company name, address, etc.). The shipping statement may also include the weight and spot price (the total value, not payout value) at the time of shipment.

Certain reports, such as profit/loss statements, may be created automatically.

A cash drawer page may be provided. The cash drawer may be specific to each user. The page may allow a manager to enter an open amount and close amount that will be reconciled with any deposits or purchases.

A police report page may be provided. the police report page may be searchable by transactions. The transactions may be filtered with a date range or by any other searchable field. The police report page may provide information sorted by customer name that includes identifying information about the customer and the transactions they made. The police report may also include pictures of each item purchased. The report may be automatically transmitted (e.g., by e-mail or fax to law enforcement officials).

A user management page may be provided. An administrator can add or remove authorized users using this page. The users may be filtered or searched using different criteria, such as name, role, or store. A store management page may be provided. For example, when there are multiple stores in an organization, each store may be an entry on the store management page. Users may be assigned to stores. Stores may also be assigned to regions to better organize a group of stores.

A reports page may be provided. The reports page may allow a user to run reports on various aspects of the business. One example of a report is a gross and Net Revenue report organized by store. Another report may show gross and net revenue organized by region. In another example, the report may show overrides organized by store. Other reports may include a list of incomplete transactions, a list of inventory on hold vs. inventory that is ready for shipment, etc. The statement may include details such as reported purity, reported weight, payout percentage, spot price per unit, amount, etc. If testing was performed to validate the commodity, testing information may also be included. A list of the included transactions may be included with the statement as well as the gross value and any handling fees applied.

The systems and methods of the present invention may be used and useful to commodity-based lenders. For example, the systems and methods of the present invention may be adapted to allow stores to accept commodities from a customer, and in exchange for those commodities, lend money to the customer based on the value of the accepted commodities.

In one embodiment of the present invention, a buyer may be able to select purchased commodities and set them aside for resale. It will be apparent that some items may be more valuable than their component parts. For example, a finely crafted necklace may be more valuable than the gold, silver, or platinum used to create the necklace. As such, a buyer may purchase a jewelry item from a consumer and instead of recycling the jewelry item, the buyer may decide to resell the jewelry item to the public. As described above, it is understood that the buyer may purchase other, non-jewelry items, from a customer.

In this embodiment, the purchased items remain in the system's inventory (and all the pertinent reports that display purchased items). However, the purchased item may also be labeled as “set aside” for resale. In this way, further reports can be created for those items that were set aside. For example, one such report may describe the profit/loss for each set aside item based on the scrap value of the item at the time of sale from the buyer to a customer. In this way, the buyer can quickly determine if the price of a set aside item is sufficient to make a profit in comparison to the profit gained by recycling the item. Another example report for this embodiment may calculate the amount of sales tax required to be collected per set aside item, per municipality.

In embodiments where a satellite store sends the commodities to a central headquarters, there may be an additional page for verifying shipment contents. For example, when the shipped commodities are received at headquarters, a second user can verify the weights and purity of the sent commodities. The central headquarters may prepare a statement about the received shipment. For example, the headquarters may prepare a statement using the system to return specific transactions. In one embodiment, incoming shipments to the central headquarters may be recorded (e.g., on video). The recording may be watermarked and uploaded such that the customer and user can look at the video, and verify its authenticity if a discrepancy occurs.

Commodities may also be sent to a refiner or broker and there may be an additional page for verifying shipment contents at the refiner or broker. For example, when the shipped commodities are received at the refiner or broker, a second user can verify the weights and purity of the sent commodities. For example, if the commodity is gold, silver, and platinum, the second user may check the purity and weight of the gold, silver, and platinum. Non-precious items (such as non-recyclable commodities) may be returned to the store. The refiner or broker may prepare a statement using the system to return specific transactions or note discrepancies in the description of the sent commodity. Additional text may be added to assist others in interpreting the statement. In one embodiment, incoming shipments to the refinery may be recorded (e.g., on video). The recording may be watermarked and uploaded such that the customer and user can look at the video, and verify its authenticity if a discrepancy occurs. Upon completion of the refining process, the customer may receive a standard refining statement. The customer can elect to receive a detailed refinement statement instead. The detailed refinement statement will serve as a detailed verification of the commodities submitted for refinement. These statements will include the weights and purity levels of the commodities as reported by the customer, as well as the weights and purity levels as verified by the refiner or broker.

In another embodiment, the system of the present invention may be used with (or integrated within) point-of-sale systems. The point-of-sale systems may be physical (e.g., a cash register) or electronic (e.g., point-of-sale software running on a server and made available over the internet). In one embodiment, the system could be used to sell commodities such as bullion, numismatic coins, stamps, etc. The system of the present invention can be embodied as an API that buyer systems integrate with.

An illustrative computer system in respect of which the methods herein described may be implemented as a computer-controlled system. The illustrative computer system is denoted generally includes a display, which may be a touchscreen display, input devices in the form of keyboard and pointing device, computer and external devices. While pointing device may be a mouse, it will be appreciated that other types of pointing device may also be used.

The computer may contain one or more processors or microprocessors, such as a central processing unit (CPU). The CPU performs arithmetic calculations and control functions to execute software stored in an internal memory, preferably random access memory (RAM) and/or read only memory (ROM), and possibly additional memory. The additional memory may include, for example, mass memory storage, hard disk drives, optical disk drives (including CD and DVD drives), magnetic disk drives, magnetic tape drives (including LTO, DLT, DAT and DCC), flash drives, removable memory chips such as EPROM or PROM, emerging storage media, such as holographic storage, or similar storage media as known in the art. This additional memory may be physically internal to the computer, or externally, or both.

The computer system may also include other similar means for allowing computer programs or other instructions to be loaded. Such means can include, for example, a communications interface which allows software and data to be transferred between the computer system and external systems and networks. Examples of communications interface can include a modem, a network interface such as an Ethernet card, a wireless communication interface, or a serial or parallel communications port. Software and data transferred via communications interface are in the form of signals which can be electronic, acoustic, electromagnetic, optical or other signals capable of being received by communications interface. Multiple interfaces, of course, can be provided on a single computer system.

Input and output to and from the computer is administered by the input/output (I/O) interface. This I/O interface administers control of the display, keyboard, external devices and other such components of the computer system. The computer also includes a graphical processing unit (GPU). The latter may also be used for computational purposes as an adjunct to, or instead of, the (CPU), for mathematical calculations.

The various components of the computer system are coupled to one another either directly or by coupling to suitable buses.

An exemplary networked mobile wireless telecommunication computing device in the form of a smartphone, laptop, or kiosk may be used with respect to the methods herein described. The smartphone, laptop, or kiosk includes a display, an input device in the form of keyboard and an onboard computer system. The display may be a touchscreen display and thereby serve as an additional input device or as an alternative to the keyboard. The onboard computer system comprises a central processing unit (CPU) having one or more processors or microprocessors for performing arithmetic calculations and control functions to execute software stored in an internal memory, preferably random access memory (RAM) and/or read only memory (ROM) and is coupled to additional memory which will typically comprise flash memory, which may be integrated into the smartphone, laptop, or kiosk or may comprise a removable flash card, or both. The smartphone, laptop, or kiosk also includes a communications interface which allows software and data to be transferred between the smartphone, laptop, or kiosk and external systems and networks. The communications interface is coupled to one or more wireless communication modules, which will typically comprise a wireless radio for connecting to one or more of a cellular network, a wireless digital network or a Wi-Fi network. The communications interface will also typically enable a wired connection of the smartphone, laptop, or kiosk to an external computer system. A microphone and speaker are coupled to the onboard computer system to support the telephone functions managed by the onboard computer system, and GPS receiver hardware may also be coupled to the communications interface to support navigation operations by the onboard computer system. Input and output to and from the onboard computer system is administered by the input/output (I/O) interface, which administers control of the display, keyboard, microphone and speaker. The onboard computer system may also include a separate graphical processing unit (GPU). The various components are coupled to one another either directly or by coupling to suitable buses.

The methods described herein may be provided as computer program products comprising a tangible computer readable storage medium, such as non-volatile memory, having computer readable program code embodied therewith for executing the method. Thus, the non-volatile memory would contain instructions which, when executed by a processor, cause the computing device to execute the relevant method.

The a computer-implemented method for tracking and validating commodities purchases herein may be implemented entirely in hardware, entirely in software, or by way of a combination of hardware and software. In a preferred embodiment, implementation is by way of software or a combination of hardware and software, which includes but is not limited to firmware, resident software, microcode, and the like. Furthermore, the above methods may be implemented in the form of a computer program product accessible from a computer usable or computer readable medium providing program code for use by or in connection with a computer or any instruction execution system. In such embodiments, the computer program product may reside on a computer usable or computer readable medium in a computer such as the memory of the onboard computer system of the smartphone, laptop, or kiosk or the memory of the computer, or on a computer usable or computer readable medium external to the onboard computer system of the smartphone, laptop, or kiosk or the computer, or on any combination thereof.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A system for tracking and validating commodity purchases comprising:
a buyer-operated computer having a municipality attribute;
an electronic data storage device;
a processor in electronic communication with the electronic data storage device;
a network connection from the processor to:
a customer database having a list of unauthorized customers;
a shipment provider;
a commodity price feed; and
the buyer-operated computer;
a buyer page, recorded on the electronic data storage device, comprising computer-readable instructions to cause the buyer-operated computer to display the buyer page, the displayed buyer page configured to:
receive a commodity description and customer information associated with a commodity;
display a current price for the commodity derived from the commodity price feed; and
display a suggested buy price for the commodity based on the current price and the municipal attribute of the buyer operated computer;
an inventory page, recorded on the electronic data storage device, comprising computer-readable instructions to cause the buyer-operated computer to display the inventory page, the displayed inventory page configured to:
track a plurality of purchased commodities; and
display a current price for each of the plurality of purchased commodities ready for shipment, the current price derived from the commodity price feed;
a shipping page, recorded on the electronic data storage device, comprising computer-readable instructions to cause the buyer-operated computer to display the shipping page, the displayed shipping page configured to:
display shipping eligibility for each purchased commodity based on a holding period; and
display shipping information for shipped commodities;
wherein the processor is configured to:
store the commodity description and customer information from the buyer-computer in the electronic data storage device;
send computer-readable instructions to cause the buyer-operated computer to display whether the received customer information matches an unauthorized customer in the customer database;
determine the commodity holding period based on the municipality attribute of the buyer-operated computer;
store the commodity holding period such that the holding period is associated with the respective commodity description in the electronic data storage device; and
retrieve shipping information and insurance information from the shipping provider for purchased commodities based on the commodity price feed.

2. The system of claim 1, wherein the processor is further configured to:
retrieve a license application from the electronic data storage device;
prepopulate the retrieved license application based on the municipality attribute of the buyer-operated computer; and
send the prepopulated license application to the buyer-operated computer.

3. The system of claim 1, wherein the buyer-operated computer has an image capture device and the displayed buyer page is configured to receive an image as a portion of the commodity description.

4. The system of claim 3, further comprising an expert-operated computer, wherein the processor is configured to:
send the commodity description to the expert-operated computer; and
receive valuation information from the expert-operated computer based on the sent commodity description.

5. The system of claim 4, wherein the image is a video.

6. The system of claim 1, wherein the commodity price feed is a New York Mercantile Exchange feed.

7. The system of claim 1, wherein the commodity price feed is a London AM or PM fix feed.

8. The system of claim 1, wherein the suggested buy price is based on the municipality attribute of the buyer-operated computer.

9. The system of claim 1, wherein the buyer page is further configured to display an incentive value based on a buy price.

10. The system of claim 1, further comprising a dashboard page, recorded on the electronic data storage device, comprising computer-readable instructions to cause the buyer-operated computer to display the dashboard page, the dashboard page configured to display messages to the buyer.

11. The system of claim 10, wherein the displayed messages comprise shipping alerts and warnings.

12. The system of claim 1, wherein the processor is also configured to generate a payout offering sheet based on the municipality attribute of the buyer-operated computer.

13. The system of claim 1, wherein the processor is also configured to retrieve a tracking number from the shipping provider, and the shipping page is also configured to display the tracking number.

14. The system of claim 1, wherein the insurance information is based on the municipality of the buyer-operated computer.

15. A method for tracking and validating commodity purchases comprising:
displaying a buyer page on a buyer-operated computer, the buyer-operated computer having a municipality attribute;
receiving, through the buyer page, a commodity description and customer information associated with a commodity to be purchased;
storing, in an electronic data storage device, the commodity description and the customer information associated with the commodity to be purchased;
validating the customer information through a customer database containing unauthorized customers, and if unauthorized, displaying, through the buyer page, a warning indicator;
displaying, through the buyer page, a current price for the commodity to be purchased derived from a commodity price feed;
displaying, through the buyer page, a suggested purchase price for the commodity based on the current price and the municipal attribute of the buyer-operated computer;
calculating, based on the municipal attribute of the buyer-operated computer, a holding period for each commodity stored in the electronic data storage device;
storing, in the electronic data storage device, the holding period associated with each commodity;
displaying, through a shipping page, a shipping eligibility for each commodity stored in the electronic data storage device based on the associated holding period;
retrieving, from a shipping interface, shipping information and insurance information from the shipping provider for purchased commodities based on the commodity price feed; and
displaying, through the shipping page, shipping information for shipped commodities.

16. The method of claim 15, further comprising the steps of:
retrieving a license application from the electronic data storage device;
prepopulating the retrieved license application based on the municipality attribute of the buyer-operated computer; and
sending the prepopulated license application to the buyer-operated computer.

17. The method of claim 15, wherein the buyer-operated computer has an image capture device and the method further comprises receiving, through the buyer page, an image as a portion of the commodity description.

18. The method of claim 17, further comprising the steps of:
sending the commodity description to an expert-operated computer; and
receiving valuation information from the expert-operated computer based on the sent commodity description.

19. The method of claim 18, wherein the image is a video.

20. The method of claim 15, wherein the commodity price feed is a New York Mercantile Exchange feed.

21. The method of claim 15, wherein the commodity price feed is a London AM or PM fix feed.

22. The method of claim 15, wherein the suggested purchase price is based on the municipality attribute of the buyer-operated computer.

23. The method of claim 15, further comprising the step of displaying, through the buyer page, is an incentive value based on a purchase price.

24. The method of claim 15, further comprising displaying, through a dashboard page, a plurality of informational messages.

25. The method of claim 24, wherein the plurality of informational messages comprise shipping alerts and warnings.

26. The method of claim 15, further comprising the step of generating a payout offering sheet based on the municipality attribute of the buyer-operated computer.

27. The method of claim 15, further comprising the step of retrieving a tracking number from the shipping provider, and displaying, through the shipping page, the tracking number.

28. The method of claim 15, wherein the insurance information is based on the municipality of the buyer-operated computer.
